(19) United States
(12) Patent Application Publication
(10) Pub. No.: US 2018/0054709 A1
(43) Pub. Date: Feb. 22, 2018

(54) ESTIMATION DEVICE, ESTIMATION METHOD, AND NON-TRANSITORY COMPUTER READABLE STORAGE MEDIUM

(71) Applicant: YAHOO JAPAN CORPORATION, Tokyo (JP)

(72) Inventor: Munehiro AZAMI, Tokyo (JP)

(73) Assignee: YAHOO JAPAN CORPORATION, Tokyo (JP)

(21) Appl. No.: 15/676,132

(22) Filed: Aug. 14, 2017

(30) Foreign Application Priority Data
Aug. 18, 2016 (JP) 2016-160875

(51) Int. Cl. H04W 4/02; G01C 21/28

(52) U.S. Cl. CPC H04W 4/027; G01C 21/28

(57) ABSTRACT

An estimation device disclosed herein includes a detection unit, an acquisition unit, and an estimation unit. The detection unit detects acceleration in a moving object. The acquisition unit acquires speed of the moving object. The estimation unit estimates a movement direction of the moving object based on a direction of the acceleration detected by the detection unit when the speed acquired by the acquisition unit changes.

### CROSS-REFERENCE TO RELATED APPLICATION(S)

The present application claims priority to and incorporates by reference the entire contents of Japanese Patent Application No. 2016-160875 filed in Japan on Aug. 18, 2016.

### BACKGROUND OF THE INVENTION

### 1. Field of the Invention

The present invention relates to an estimation device, an estimation method, and a non-transitory computer readable storage medium having stored therein an estimation program.

### 2. Description of the Related Art

Conventionally, car navigation (hereinafter, also referred to as “guidance”) techniques to guide a vehicle on which a user is riding to a destination using a portable terminal device such as a smartphone have been known. A terminal device that performs such guidance uses a satellite positioning system such as a global positioning system (GPS) to specify a current location of a vehicle and displays a screen representing a map or an induced route and the specified current location in a superimposed manner.

Meanwhile, the terminal device is incapable of displaying the current location in a place where it is difficult to receive a signal from a satellite such as the inside of a tunnel. The same problem is common generally in positioning techniques using an outside signal (for example, a radio wave from a mobile phone (cellular) base station, a wireless LAN radio wave, or the like) without being limited to the GPS. In this regard, a technique of autonomous positioning to estimate a current location of a vehicle using acceleration measured by an accelerometer is conceivable. For example, proposed is a technique in which a device including an accelerometer is fixed in a vehicle in a predetermined posture, and a traveling state of the vehicle is estimated based on acceleration detected by the device (see the publication of Japanese Patent No. 4736866).

However, installation postures of the terminal device such as the smartphone inside a car are different each time depending on a type of the car on which a user rides, a use state of a holder holding the terminal device, and the like. Thus, it may be difficult to estimate the traveling state of a vehicle.

For example, the terminal device includes the accelerometer that detects the acceleration in an axial direction having the terminal device as a reference, and thus, converts a direction of the detected acceleration into a direction having a movement direction of the vehicle as a reference based on the installation posture of the terminal device. In addition, the terminal device estimates the movement direction and speed of the vehicle using the acceleration whose direction has been converted and specifies a current location of the vehicle based on the estimated movement direction and speed. However, when the installation posture is unknown or when the installation posture changes, the terminal device is incapable of converting the direction of acceleration, and accuracy in estimation of the traveling state deteriorates.

### SUMMARY OF THE INVENTION

It is an object of the present invention to at least partially solve the problems in the conventional technology.

An estimation device includes a detection unit that detects acceleration in a moving object, an acquisition unit that acquires speed of the moving object, and an estimation unit that estimates a movement direction of the moving object based on a direction of the acceleration detected by the detection unit when the speed acquired by the acquisition unit changes.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view for describing an example of an operational effect exerted by a terminal device according to an embodiment;

FIG. 2 is a diagram describing an example of a functional configuration of the terminal device according to the embodiment;

FIG. 3 is a view illustrating an example of information registered in a GPS speed database according to the embodiment;

FIG. 4 is a view illustrating an example of information registered in an acceleration database according to the embodiment;

FIG. 5 is a view illustrating an example of information registered in an average value database according to the embodiment;

FIG. 6 is a flowchart describing an example of flow of a guidance process executed by the terminal device according to the embodiment;

FIG. 7 is a flowchart describing an example of flow of an acquisition process executed by the terminal device according to the embodiment;

FIG. 8 is a flowchart describing an example of flow of a detection process executed by the terminal device according to the embodiment;

FIG. 9 is a flowchart describing an example of flow of an estimation process executed by the terminal device according to the embodiment;

FIG. 10 is a view illustrating an example of acceleration acquired by the terminal device according to the embodiment;

FIG. 11 is a view illustrating an example of a process of processing in which the terminal device according to the embodiment estimates a movement direction; and

FIG. 12 is a view illustrating an example of a process of detecting a change of an installation posture by the terminal device according to the embodiment.

### DETAILED DESCRIPTION OF THE PREFERRED EMBODIMENTS

Hereinafter, modes (hereinafter, referred to as “embodiments”) for carrying out an estimation device, an estimation method, and a non-transitory computer readable storage medium having stored therein an estimation program according to the present application will be described in detail with reference to the drawings. Incidentally, the estimation device, the estimation method, and the non-transitory computer readable storage medium having stored therein the estimation program according to the present application are not limited by the embodiment. In addition, the same parts and processes in the following respective embodiments will be denoted by the same reference numerals, and the redundant descriptions thereof will be omitted.

In addition, an example of car navigation, which guides a vehicle on which a user rides to a destination will be described as a process executed by the estimation device in the following description, but the embodiment is not limited thereto. For example, the estimation device may execute the process of guiding the user to the destination by executing a process to be described hereinafter even in a case where the user is walking or in the case of using a transportation means other than a vehicle, such as a train.

### 1. Overview of Movement State

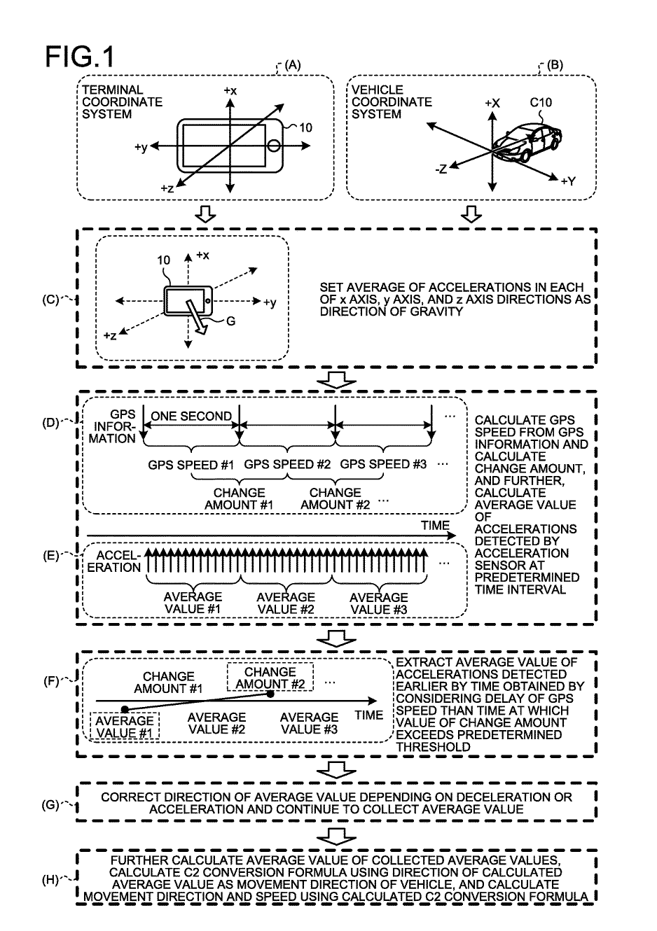

First, a concept of a movement mode determined by a terminal device 10 which is an example of the estimation device will be described with reference to FIG. 1. FIG. 1 is a view for describing an example of an operational effect exerted by a terminal device according to an embodiment. For example, a terminal device 10 is a terminal device such as a smart phone, a tablet terminal, a mobile terminal such as a personal digital assistant (PDA), and a laptop personal computer (PC), and is a terminal device capable of communicating with an arbitrary server via a network N such as a mobile communication network and a wireless local area network (LAN).

In addition, the terminal device 10 has a car navigation function of guiding a vehicle C10 on which a user rides to a destination. For example, when receiving input of the destination from the user, the terminal device 10 acquires route information, configured to induce the user to the destination, from a server (not illustrated) or the like. For example, the route information includes a route to the destination that can be used by the vehicle C10, information on expressway included in the route, traffic congestion information on the route, a facility serving as a landmark of guidance, information on a map displayed on a screen, and data such as a sound to be output at the time of guidance and an image such as the map.

In addition, the terminal device 10 has a positioning function of specifying a position of the terminal device 10 (hereinafter referred to as a “current location”) at predetermined time intervals using a satellite positioning system such as a global positioning system (GPS). Further, the terminal device 10 displays the image such as the map included in the route information on a liquid crystal screen, an electroluminescence or light emitting diode (LED) screen (hereinafter, simply referred to as the “screen”), and further, displays the specified current location on the map each time. In addition, the terminal device 10 displays a left turn, a right turn, a change of a lane to be used, an expected arrival time to a destination, and the like according to the specified current location, or outputs these types of information using voice from a speaker or the like of the terminal device 10 and the vehicle C10.

Here, signals transmitted from a plurality of satellites are received in the satellite positioning system, and the current location of the terminal device 10 is specified using the received signals. Thus, when it is difficult to appropriately receive the signal transmitted from the satellite, such as in a tunnel or a place between buildings, the terminal device 10 is incapable of specifying the current location. In addition, an application or the like that implements guidance in the terminal device 10 does not have a function of acquiring information such as speed, a movement direction, and the like from the vehicle C10. Thus, it is possible to conceive a technique in which an acceleration sensor to measure acceleration is installed on the terminal device 10 and the current position of the terminal device 10 is estimated based on the acceleration measured by the acceleration sensor. For example, it is possible to conceive a technique to perform an estimation process of estimating movement speed, a movement direction, and the like of the terminal device 10 and stop determination in which whether the terminal device 10 is moving or stopped based on the acceleration measured by the acceleration sensor.

A more specific example will be described. For example, when it is difficult to appropriately receive the signal transmitted from the satellite, the terminal device 10 determines that the vehicle C10 has entered a tunnel or the like and advances an estimated position without any change with vehicle speed and a movement direction specified last. In addition, the terminal device 10 determines whether or not the vehicle C10 is stopped based on the measured acceleration, and stops movement of the estimated position when it is determined that the vehicle C10 is stopped. On the other hand, when it is determined that the vehicle C10 is not stopped, the terminal device 10 estimates the movement speed of the vehicle C10 as the moving object using the measured acceleration and continues guidance assuming movement at the estimated movement speed.

1-1. Example of Speed Estimation Technique

Here, an example of a speed estimation technique to estimate the movement speed of the vehicle C10 will be described. Incidentally, the technique illustrated herein is an example of a technique that is a preliminary step of the present embodiments, and does not belong to the original related art. That is, the technique illustrated herein is a technique that the present applicant confidentially performs for the purpose of development, testing, research, and the like, and is not a technique departing from secrets such as what is so-called public knowledge, public use, or public knowledge from the literature.

For example, as illustrated in (A) of FIG. 1, the terminal device 10 sets a short-length direction of the screen as an x axis, a long-length direction of the screen as a y axis, and a direction perpendicular to the screen as a z axis, and measures acceleration in each of x axis, y axis, and z axis directions. For example, when the screen is set as the front, the terminal device 10 sets the front side to a +z axis direction and the back side to a −z axis direction, and measures acceleration in a terminal coordinate system in which an upper side of the screen at the time of using the terminal device 10 is set as a +x axis direction, a lower side of the screen is set as a −x axis direction, a left side of the screen is set as a +y axis direction, and a right side of the screen is set as a −y axis direction.

On the other hand, the movement direction and speed of the vehicle C10 used by the user are expressed in a vehicle coordinate system in which a progressing direction of the vehicle C10 is set as a Z axis, and on a plane perpendicular to the Z axis, a direction in which the vehicle C10 turns right or left at the time of progressing is set as a Y axis direction, and an up-and-down direction of the vehicle C10 is set as an X axis direction as illustrated in (B) of FIG. 1. For example, the movement direction and the speed of the vehicle C10 are expressed in the vehicle coordinate system in which an up direction of the vehicle C10 is set as +X axis direction, a down direction (for example, a ground side) is set as a −X axis direction, a left-turning direction is set as a +Y axis direction, a right-turning direction is set as a −Y axis direction, a rear direction of the vehicle C10 is set as a +Z axis direction, and a front direction thereof is set as a −Z axis direction.

Here, the vehicle coordinate system and the terminal coordinate system have deviations depending on an installation posture and the like of the terminal device 10. Thus, for example, the terminal device 10 estimates a direction of gravity, that is, the −X axis direction of the vehicle coordinate system using the acceleration measured in the terminal coordinate system, specifies the movement direction of the vehicle C10 using a variance of the acceleration generated when the vehicle C10 accelerates or decelerates, or changes the movement direction, and obtains a rotation matrix to convert the acceleration measured in the terminal coordinate system into the vehicle coordinate system based on an estimated reference direction and the movement direction. Further, the terminal device 10 converts the acceleration in the terminal coordinate system into the acceleration in the vehicle coordinate system using the rotation matrix, and executes stop determination on whether or not the vehicle C10 is stopped, and estimation of the movement speed of the vehicle C10 using a converted acceleration.

For example, the terminal device 10 collects information on an amplitude, a frequency, an average value, a standard deviation, a maximum value, a minimum value, and the like in each axis direction of the converted acceleration as a feature amount. In addition, the terminal device 10 accumulates a feature amount acquired when the speed of the vehicle C10 is equal to or higher than a predetermined threshold as a feature amount during traveling, and accumulates a feature amount acquired when the speed of the vehicle C10 is equal to or lower than the predetermined threshold as a feature amount during stop.

Further, the terminal device 10 learns a stop determination model (for example, obtained by a support vector machine (SVM) or the like) to determine whether or not the vehicle C10 is stopped using the accumulated feature amount, and determines whether or not the vehicle C10 is stopped using the learned stop determination model in a case where it is difficult to use the satellite positioning system, such as in the tunnel. Further, when determining that the vehicle C10 is not stopped, the terminal device 10 estimates the movement speed of the vehicle C10 based on an integrated value of acceleration values on a plane including the movement direction among accelerations acquired in the vehicle coordinate system.

However, the movement direction of the vehicle C10 is specified using the variance of the acceleration generated when the vehicle C10 moves in such a technique, and thus, it is necessary for the vehicle C10 to accelerate or decelerate plural times in order to obtain the rotation matrix so that it takes time to obtain the rotation matrix. As a result, when the vehicle C10 enters the tunnel before obtaining the rotation matrix after start of guidance, for example, there is a problem that it is difficult to obtain the rotation matrix and to start the stop determination. In addition, data obtained for a certain period is used at the time of determining the movement direction of the vehicle C10 in such a technique. Thus, there is a possibility that it is difficult to accurately determine the movement direction depending on the quality of data used to determine the movement direction.

In addition, there is a case where the user gets off a car possessing the terminal device 10 in a service area or the like. As a result, it is necessary to specify the movement direction again and to obtain the rotation matrix again based on the specified movement direction and the reference direction because the rotation matrix changes when the posture of the terminal device 10 changes. However, even when such a process is executed, it is difficult to start the stop determination until the movement direction is specified. In addition, a deviation occurs between the terminal coordinate system and the vehicle coordinate system when a road is inclined, and thus, an error is likely to occur.

Incidentally, it is also possible to conceive a technique in which an average value of accelerations is calculated without coordinate conversion of the acceleration measured in the terminal coordinate system and the stop determination model is learned from a feature amount of the calculated average value. In such a technique, however, the installation posture of the terminal device 10 is unknown, and thus, it is necessary to unconditionally learn the stop determination model every time the guidance is started. In addition, even when such a technique is used, it is necessary to learn the stop determination model again if the installation posture of the terminal device 10 changes, and further, the error is likely to occur when the road is inclined.

### 2. Regarding Determination Process Executed by Terminal Device 10 According to Embodiment

Then, the terminal device 10 executes the following determination process. For example, the terminal device 10 detects acceleration of a moving object in which the terminal device 10 is installed, such as the vehicle C10. In addition, the terminal device 10 acquires speed of the moving object. Further, the terminal device 10 estimates a movement direction of the moving object based on a direction of the acceleration detected when the acquired speed changes.

Hereinafter, an example of a functional configuration and operational effects of the terminal device 10 that implements the above-described determination process will be described with reference to the drawings.

2-1. Example of Functional Configuration

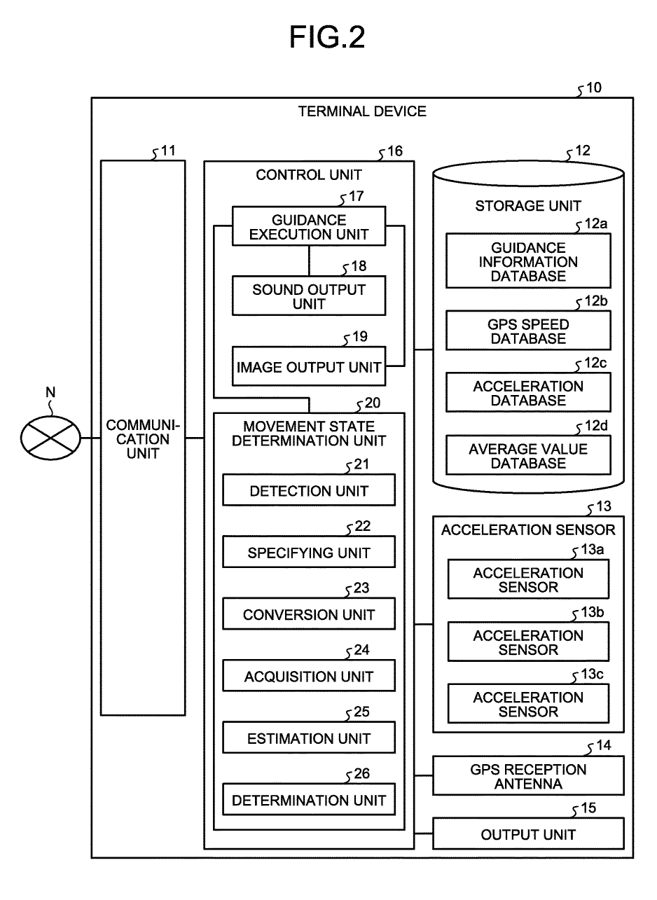

FIG. 2 is a diagram describing an example of the functional configuration of the terminal device according to the embodiment. As illustrated in FIG. 2, the terminal device 10 includes a communication unit 11, a storage unit 12, a plurality of acceleration sensors 13a to 13c (hereinafter, collectively referred to as an “acceleration sensor 13” in some cases), a GPS reception antenna 14, an output unit 15, and a control unit 16. The communication unit 11 is implemented using, for example, a network interface card (NIC) or the like. Further, the communication unit 11 is connected to a network N in a wired or wireless manner, and performs transmission and reception of information between the terminal device 10 and a distribution server, which distributes route information indicating a route to a destination when receiving the destination from the terminal device 10.

The storage unit 12 is implemented using, for example, a semiconductor memory element such as a random access memory (RAM) and a flash memory or a storage device such as a hard disk and an optical disk. In addition, the storage unit 12 includes a guidance information database 12a, a GPS speed database 12b, an acceleration database 12c, and an average value database 12d which are various types of data used to execute guidance.

Various types of data used when the terminal device 10 performs guidance are registered in the guidance information database 12a. For example, the route information to the destination received from the server (not illustrated) or the like is stored in the guidance information database 12a. In addition, various types of images, voice data and the like output for guidance are stored in the guidance information database 12a.

In the GPS speed database 12b, GPS speed, which is the speed of the vehicle C10 acquired using an arbitrary positioning system such as the GPS is registered. More specifically, the GPS speed calculated from a difference between positions of the vehicle C10 acquired at predetermined time intervals (for example, one second) using the GPS is registered in the GPS speed database 12b. Incidentally, a description will be given regarding an example in which the terminal device 10 acquires the GPS speed from the difference between positions of the vehicle C10 in the following description, but the embodiment is not limited thereto. For example, the terminal device 10 may acquire the speed of the vehicle C10 from a signal received from a GPS satellite using the Doppler effect. For example, the terminal device 10 may acquire the speed of the vehicle C10 based on a wave number change of a signal (carrier wave) received from the GPS satellite.

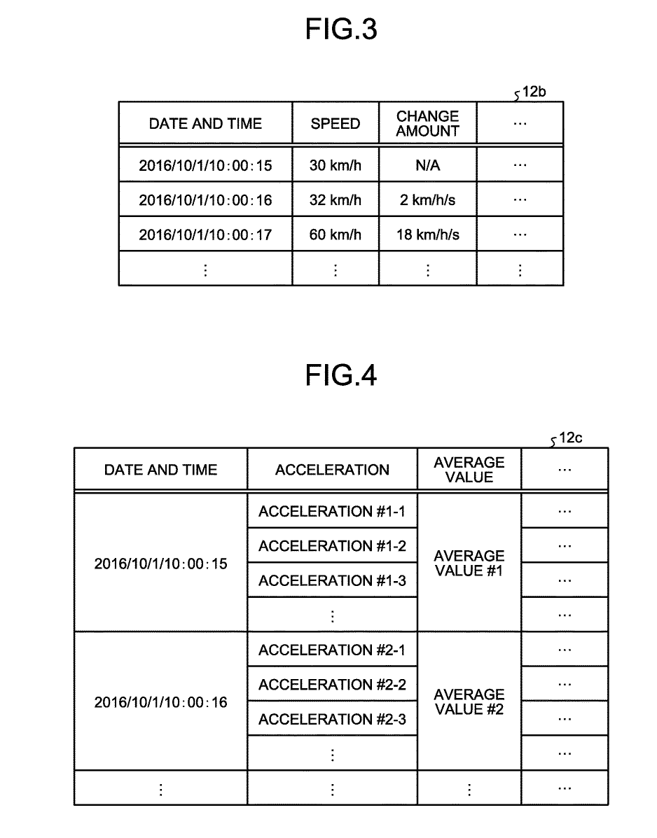

For example, FIG. 3 is a view illustrating an example of information registered in the GPS speed database according to the embodiment. As illustrated in FIG. 3, information having items such as “date and time”, “speed”, and “change amount” is registered in the GPS speed database 12b. Here, “date and time” is information indicating the estimated date and time when the vehicle C10 moves at the associated “speed”. More specifically, the “date and time” is the date and time when one of two GPS signals, used at the time of calculating the GPS speed indicated by the associated “speed”, is received or a median of dates and times of the two GPS signals. This “date and time” is information indicating the date and time when the vehicle C10 moves at the speed indicated by the associated “speed”.

In addition, “speed” is information indicating the GPS speed, and for example, the movement speed of the vehicle C10, calculated by dividing a distance between a position indicated by a GPS signal received at a certain date and time and a position indicated by a GPS signal received immediately before the GPS signal, by an interval between times when the respective GPS signals are received is registered. In addition, “change amount” is information indicating a difference between the associated “speed” and the previously acquired “speed”, that is, a change amount of the GPS speed.

For example, a date and time “2016/10/1/10:00:15”, speed “30 km/h”, and a change amount “N/A” are registered in the GPS speed database 12b in association with each other in the example illustrated in FIG. 3. Such information indicates that the speed “30 km/h” is acquired as the GPS speed of the vehicle C10 in the date and time “2016/10/1/10:00:15”. In addition, a date and time “2016/10/1/10:00:16”, speed “32 km/h”, and a change amount “2 km/h/s” are registered in the GPS speed database 12b in association with each other in the example illustrated in FIG. 3. Such information indicates that the speed “32 km/h” is acquired as the GPS speed of the vehicle C10 in the date and time “2016/10/1/10:00:16”, and a difference from the previously acquired speed, that is, the speed “30 km/h” in the date and time “2016/10/1/10:00:15” is the change amount “2 km/h/s”. Here, the change amount “2 km/h/s” indicates that acceleration is performed at a rate of 2 km/h per second.

The acceleration measured by the acceleration sensor 13 of the terminal device 10 is assumed in the acceleration database 12c. More specifically, the acceleration measured by the acceleration sensor 13 at a predetermined time interval (for example, 0.02 seconds) is held in the acceleration database 12c during a predetermined period.

For example, FIG. 4 is a view illustrating an example of information registered in the acceleration database according to the embodiment. As illustrated in FIG. 4, information having items such as “date and time”, “acceleration”, and “average value” is registered in the acceleration database 12c. Here, “date and time” illustrated in FIG. 4 is information indicating a date and time when acceleration associated therewith is measured at a predetermined interval. In addition, “acceleration” is information indicating acceleration detected at a date and time associated therewith. In addition, “average value” is an average value of associated accelerations, that is, an average value of accelerations detected at a date and time indicated by the associated “date and time”.

For example, when the acceleration sensor 13 measures acceleration at a rate of 50 times per second (that is, an interval of 0.02 seconds), 50 accelerations measured during an arbitrary one second and an average value of the accelerations, and a median of the dates and times when the respective accelerations are measured are registered in the acceleration database 12c in the state of being associated with each other. More specifically, a date and time “2016/10/1/10:00:15”, accelerations “acceleration #1-1” to “acceleration #1-3”, and an average value “average value #1” are registered in the acceleration database 12c in association with each other in the example illustrated in FIG. 4. Such information indicates that a median of dates and times when the accelerations “acceleration #1-1” to “acceleration #1-3” are measured is the date and time “2016/10/1/10:00:15” and an average value of the accelerations “acceleration #1-1 “to” acceleration #1-3” is the average value “average value #1”. Although conceptual values such as “acceleration #1-1” and “average value #1” are described in FIG. 4, in practice, values indicating acceleration and an average value are registered.

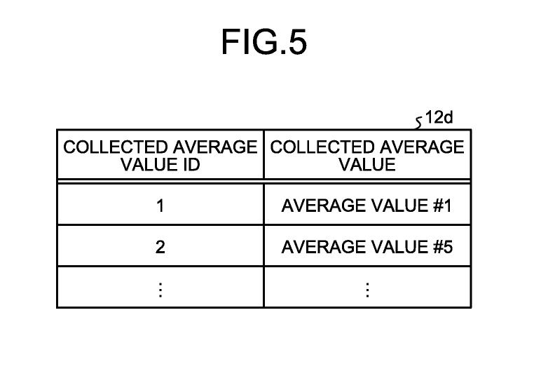

A collected average value, which is an average value collected from the acceleration database 12c by a process to be described later, is registered in the average value database 12d. For example, FIG. 5 is a view illustrating an example of information registered in the average value database according to the embodiment. As illustrated in FIG. 5, information having items such as “collection average value identifier (ID)” and “collection average value” is registered in the average value database 12d. Here, “collected average value ID” is an identifier to identify a collected average value, and “collected average value” is a collected average value which is an average value collected from the acceleration database 12c.

For example, a collected average value ID “1” and a collected average value “average value #1” are registered in association with each other in the average value database 12d in the example illustrated in FIG. 5. Such information indicates that the average value “average value #1” is collected from the acceleration database 12c as the collected average value.

Returning to FIG. 2, the description will be continued. The acceleration sensor 13 measures a magnitude and a direction of acceleration according to the terminal device 10 at a predetermined time interval. For example, the acceleration sensor 13a measures acceleration in the x axis direction in the terminal coordinate system. The acceleration sensor 13b measures acceleration in the y axis direction in the terminal coordinate system. The acceleration sensor 13c measures acceleration in the z axis direction in the terminal coordinate system. That is, the terminal device 10 can acquire a vector indicating the direction and the magnitude of the acceleration with respect to the terminal device 10 by setting the acceleration measured by each of the acceleration sensors 13a to 13c as the acceleration in each axis direction of the terminal coordinate system.

The GPS reception antenna 14 is an antenna configured to receive a signal used in the satellite positioning system such as the GPS from a satellite. In addition, the output unit 15 is a screen configured to display a map and a current location at the time of performing guidance or a speaker configured to output sound. Incidentally, the acceleration sensor 13 and the GPS reception antenna 14 are implemented by predetermined hardware.

The control unit 16 is implemented, for example, as various programs, stored in the storage device inside the terminal device 10 are executed by a central processing unit (CPU), a micro processing unit (MPU), an application specific integrated circuit (ASIC), a field programmable gate array (FPGA), or the like using a storage area such as a RAM as a work area. In the example illustrated in FIG. 2, the control unit 16 includes a guidance execution unit 17, a sound output unit 18, an image output unit 19, and a movement state determination unit 20 (hereinafter, collectively referred to as processors 17 to 20 in some cases). In addition, the movement state determination unit 20 includes a detection unit 21, a specifying unit 22, a conversion unit 23, an acquisition unit 24, an estimation unit 25, and a determination unit 26.

Incidentally, a connection relationship among the processors 17 to 20 provided in the control unit 16 is not limited to the connection relationship illustrated in FIG. 2, but may be other connection relationships. In addition, although each of the processors 17 to 20 implements and executes functions and operations (for example, FIG. 1) of the guidance process as will be described hereinafter, these are functional units organized for the sake of description, and do not necessarily matches actual hardware elements or software modules. That is, the terminal device 10 may implement and execute the guidance process in arbitrary functional units as long as the functions and operations of the following guidance process can be implemented and executed.

2-2. Example of Operational Effect of Guide Process

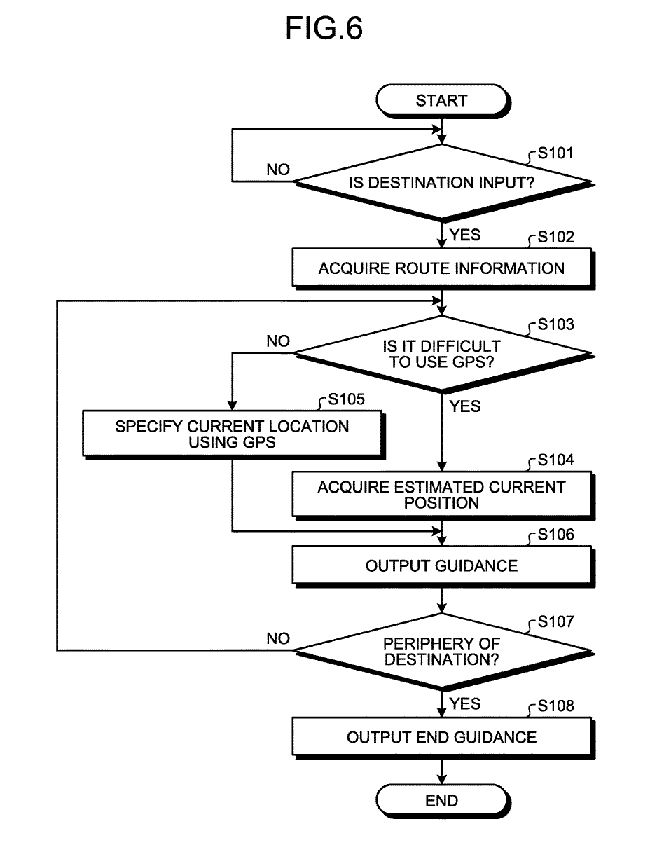

Hereinafter, a content of the guidance process to be executed and implemented by each of the processors 17 to 20 will be described with reference to a flowchart illustrated in FIG. 6. FIG. 6 is the flowchart describing an example of flow of the guidance process executed by the terminal device according to the embodiment.

First, the guidance execution unit 17 determines whether or not a destination has been input from the user (Step S101). Further, when the destination is input (Step S101: Yes), the guidance execution unit 17 acquires route information from an external server (not illustrated) (Step S102). Here, the guidance execution unit 17 determines whether or not the GPS is available (Step S103).

For example, the guidance execution unit 17 determines that the GPS is not available (Step S103: Yes), for example, when it is difficult for the GPS reception antenna 14 to receive a signal from a satellite or when the number of satellites from which signals have been received is smaller than a predetermined threshold, and acquires a current position from a movement direction and speed of the vehicle C10 estimated by the movement state determination unit 20 (Step S104). For example, the guidance execution unit 17 acquires the current location estimated by the movement state determination unit 20. Incidentally, a specific content of a process of estimating the current location of the vehicle C10 executed by the movement state determination unit 20 will be described later.

On the other hand, when determining that the GPS is available (Step S103: No), the guidance execution unit 17 specifies a current location using the GPS (Step S105). Further, the guidance execution unit 17 controls the sound output unit 18 and the image output unit 19, and outputs guidance using the current location obtained using the GPS or the estimated current location (Step S106). For example, the sound output unit 18 outputs sound indicating the current location, a direction in which the vehicle C10 is to travel, and the like from the output unit 15 in accordance with the control by the guidance execution unit 17. In addition, the image output unit 19 outputs an image in which a current location and a surrounding map are superimposed on each other, and an image indicating the direction in which the vehicle C10 is to travel, and the like from the output unit 15 in accordance with the control by the guidance execution unit 17.

Subsequently, the guidance execution unit 17 determines whether or not the current location is around the destination (Step S107). Further, when determining that the current location is around the destination (Step S107: Yes), the guidance execution unit 17 controls the sound output unit 18 and the image output unit 19 to output end guidance indicating end of guidance (Step S108), and ends the process. On the other hand, when determining that the current location is not around the destination (Step S107: No), the guidance execution unit 17 executes Step S103. Incidentally, when the destination is not input (Step S101: No), the guidance execution unit 17 waits until input is made.

2-3. Example of Operational Effect of Acquisition Process

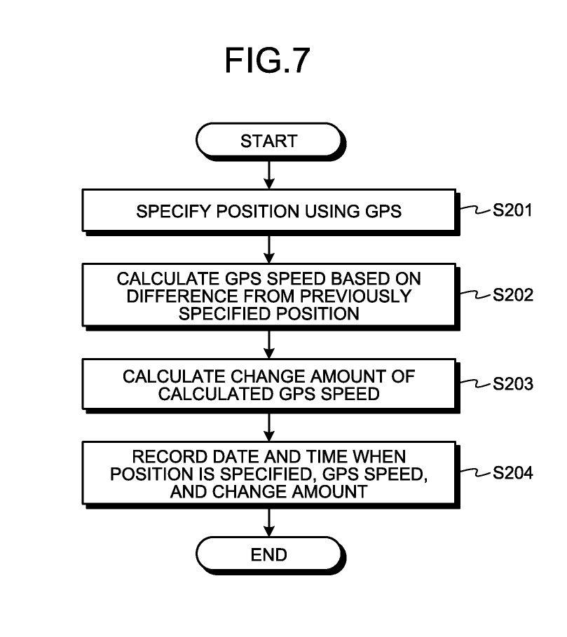

Next, a content of an acquisition process executed and implemented by the acquisition unit 24 will be described with reference to a flowchart illustrated in FIG. 7. FIG. 7 is the flowchart describing an example of flow of the acquisition process executed by the terminal device according to the embodiment.

For example, the acquisition unit 24 executes the acquisition process illustrated in FIG. 7 at a predetermined time interval (for example, one second). First, the acquisition unit 24 specifies a position of the terminal device 10, that is, a position of the vehicle C10 using the GPS (Step S201). Further, the acquisition unit 24 calculates GPS speed based on a difference between a position previously specified using the GPS and the position specified in Step S201 (Step S202).

In addition, the acquisition unit 24 calculates a difference between the previously calculated GPS speed and a newly calculated GPS speed as a change amount (Step S203). Incidentally, for example, when calculating the GPS speed every t seconds, the acquisition unit 24 may use a value obtained by dividing the difference between the previously calculated GPS speed and the newly calculated GPS speed by t as the change amount. Further, the acquisition unit 24 registers a date and time when the position of the vehicle C10 is specified in Step S201, the calculated GPS speed, and the calculated change amount in the GPS speed database 12b in association with each other (Step S204). That is, the acquisition unit 24 executes processes of specifying a position of the vehicle C10, which is the moving object, at a predetermined time interval using a predetermined position positioning system, and acquiring speed of the vehicle C10 as the moving object based on a change in the specified position.

For example, as illustrated in (D) in FIG. 1, the acquisition unit 24 acquires GPS information at an interval of one second, and acquires GPS speed #1, GPS speed #2, and GPS speed #3 at an interval of one second based on a difference between positions indicated by the acquired pieces of GPS information. Further, the acquisition unit 24 calculates a change amount #1 from the GPS speed #1 and the GPS speed #2, and calculates a change amount #2 from the GPS speed #2 and the GPS speed #3.

Incidentally, the acquisition unit 24 may acquire the speed of the vehicle C10 via a general standard configured to acquire information from a control device of an information system or a control system provided in the vehicle C10 such as an on-board diagnostics (OBD) terminal. In addition, the acquisition unit 24 may acquire the movement speed of the vehicle C10 from the control device of the information system or the control system provided in the vehicle C10 using a short-range wireless communication technology such as Bluetooth (registered trademark). When the speed is directly acquired from the control device provided in the vehicle C10 in this manner, the accuracy of speed is improved and a delay can be suppressed as compared with the case where the movement speed is estimated using the GPS. Thus, the terminal device 10 can improve accuracy in estimation of the movement direction of the vehicle C10 in an estimation process to be described later.

2-4. Example of Operational Effect in Detection Process

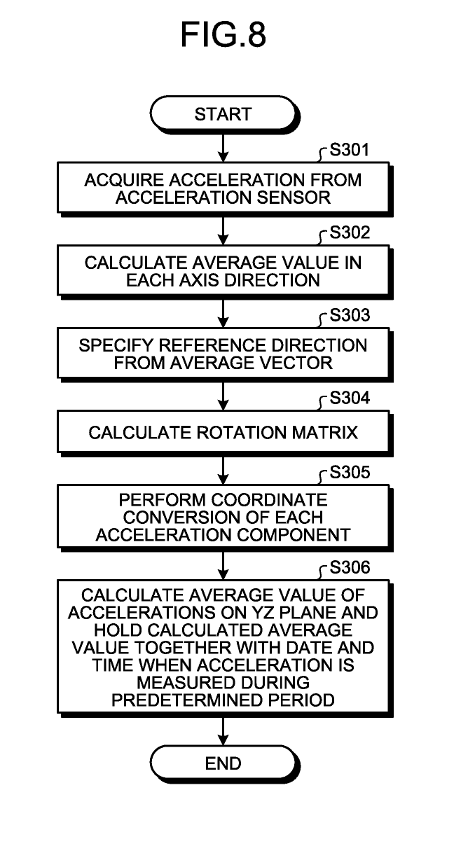

Next, an example of flow of a detection process executed by the detection unit 21, the specifying unit 22, and the conversion unit 23 will be described with reference to a flowchart illustrated in FIG. 8. FIG. 8 is the flowchart describing the example of the flow of the detection process executed by the terminal device according to the embodiment.

For example, the detection unit 21 acquires acceleration from the acceleration sensor 13 (Step S301). Specifically, the acceleration sensor 13 acquires a magnitude of the acceleration measured for each (x, y, z) axis direction of the terminal coordinate system at a predetermined time interval. In addition, the detection unit 21 calculates an average value of the magnitudes of the accelerations measured by the acceleration sensor 13 during a predetermined period for each axis direction of the terminal coordinate system (Step S302). For example, the detection unit 21 collects the accelerations of the terminal coordinate system detected by the acceleration sensor 13 every 20 milliseconds (that is, at a rate of 50 times during one second) for one second. Further, the detection unit 21 calculates an average value xₘ of values in the x axis direction, an average value yₘ of values in the y axis direction, and an average value zₘ of values in the z axis direction of the respective collected accelerations, respectively, and sets a vector (xₘ, yₘ, zₘ) formed of the calculated average values in the respective axial directions as an average vector G.

Subsequently, the specifying unit 22 specifies a reference direction based on the acceleration calculated by the detection unit 21 (Step S303). More specifically, as illustrated in (C) in FIG. 1, the specifying unit 22 sets a direction of the average vector G, formed of the average values of the accelerations calculated by the detection unit 21, as the reference direction.

Subsequently, the conversion unit 23 calculates a rotation matrix that causes a predetermined axial direction of the terminal coordinate system to match the reference direction set by the specifying unit 22 (Step S304). Further, the conversion unit 23 converts each component of the acceleration, acquired in the terminal coordinate system by the detection unit 21, using the calculated rotation matrix (Step S305). That is, the conversion unit 23 converts the acceleration acquired by the detection unit 21 into acceleration of a coordinate system having the reference direction as a reference instead of the vehicle coordinate system.

For example, the specifying unit 22 sets the direction of the average vector G of the acceleration as the reference direction. Further, the conversion unit 23 calculates a rotation matrix as a C1 conversion formula such that the −x axis direction of the terminal coordinate system and the direction of the average vector G match each other. Here, when the vehicle C10 is stopped or the like, it is predicted that the direction of the average vector G matches the direction of a gravitational acceleration. Thus, the conversion unit 23 matches the −x axis direction of the terminal coordinate system and the X axis direction of the vehicle coordinate system by matching the −x axis direction of the terminal coordinate system and the direction of the average vector G.

Incidentally, the conversion unit 23 may determine whether or not the vehicle C10 is stopped using the SVM, the GPS speed, or the like, and set the direction of the average vector G of the acceleration acquired by the acceleration sensor 13 as the reference direction when it is determined that the vehicle C10 is stopped. In addition, the conversion unit 23 may adopt an arbitrary rotation matrix as long as the rotation matrix enables the −x axis direction of the terminal coordinate system and the direction of the average vector G to match each other. That is, the conversion unit 23 may adopt a rotation matrix that causes the y axis direction or the z axis direction to be rotated into an arbitrary direction. In addition, a process of converting the coordinate system of the acceleration measured by the acceleration sensor 13 using the C1 conversion formula that causes the −x axis direction of the terminal coordinate system and the direction of the average vector G to match each other will be sometimes described as C1 conversion in the following description.

Further, the conversion unit 23 calculates an average value on a YZ plane of accelerations subjected to the C1 conversion, and holds the calculated average value together with a date and time when the acceleration has been measured during a predetermined period (Step S306). For example, the conversion unit 23 performs the C1 conversion of the acceleration acquired by the detection unit 21 into acceleration of a coordinate system in which the y axis does not match the Y axis and the z axis does not match the Z axis (the coordinate system having the reference direction as the reference). In addition, the conversion unit 23 extracts accelerations on the YZ plane, that is, a plane perpendicular to the x axis direction among the accelerations detected during a predetermined period (for example, one second).

Further, the conversion unit 23 registers the extracted accelerations, the date and time when each acceleration is detected, and an average value of the extracted accelerations in the acceleration database 12c in association with each other. For example, the conversion unit 23 registers a date and time serving as a start point, an end point, or a midpoint during one second, accelerations on the YZ plane of the accelerations measured during the one second, and an average value of the accelerations in the acceleration database 12c in association with each other.

In this manner, the conversion unit 23 applies the rotation matrix to the measured accelerations and acquires the average value #1, the average value #2, and the average value #3 of the accelerations on the YZ plane as illustrated in (E) in FIG. 1. That is, the terminal device 10 calculates the GPS speed from the GPS information and calculates the change amount, and further, calculates the average value of the accelerations detected by the acceleration sensor 13 at a predetermined time interval.

Incidentally, when the above-described C1 conversion is performed on the acceleration measured by the acceleration sensor 13, the x axis of the terminal coordinate system and the X axis of the vehicle coordinate system can be made to match each other, but, it is not always possible to make the y axis or the z axis of the terminal coordinate system match the Y axis or the Z axis of the vehicle coordinate system. Thus, the terminal device 10 estimates the movement direction of the vehicle C10 based on the acceleration by the estimation process to be described later, and calculates a rotation matrix that causes the y axis or the z axis of the terminal coordinate system to match the Y axis or the Z axis of the vehicle coordinate system as a C2 conversion formula.

2-5. Example of Operational Effect in Estimation Process

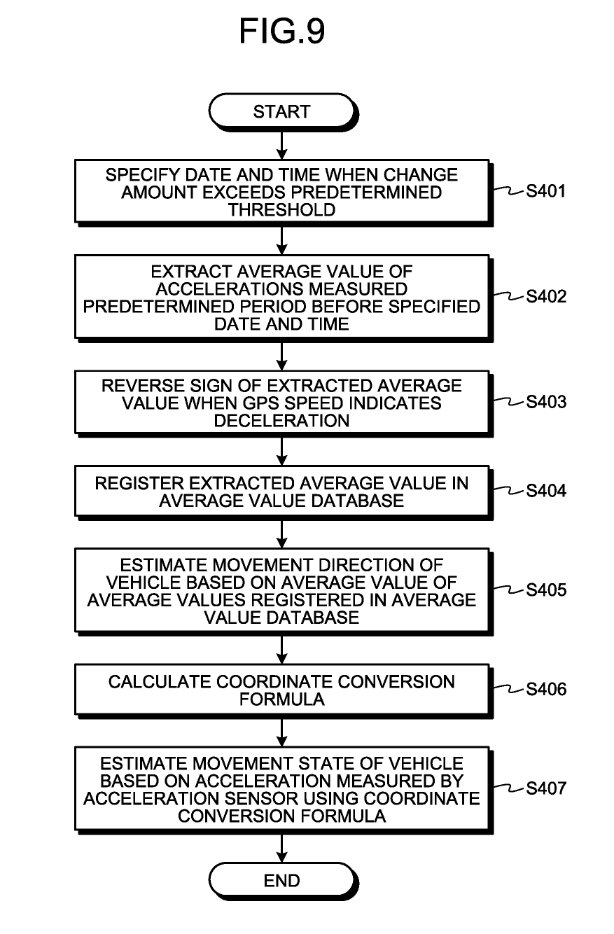

Next, an example of flow of the estimation process executed by the estimation unit 25 and the determination unit 26 will be described with reference to a flowchart illustrated in FIG. 9. FIG. 9 is the flowchart describing the example of the flow of the estimation process executed by the terminal device according to the embodiment.

For example, the estimation unit 25 refers to the GPS speed database 12b and specifies a date and time when a change amount exceeds a predetermined threshold (Step S401). That is, the estimation unit 25 specifies the date and time when it is estimated that acceleration greater than a predetermined threshold is applied to the vehicle C10 by acceleration, deceleration, or the like, using the GPS speed. It is predicted that information on the acceleration detected at such timing includes information indicating a magnitude or a direction of acceleration caused by acceleration or deceleration, that is, information indicating a movement direction of the vehicle C10. Thus, the estimation unit 25 estimates the movement direction of the vehicle C10 by executing the following process using the acceleration detected at the specified date and time. More specifically, the estimation unit 25 estimates the movement direction of the vehicle C10 based on the direction of the acceleration detected when the acquired change amount in speed exceeds the predetermined threshold.

For example, the estimation unit 25 extracts an average value of the accelerations measured a predetermined period before the specified date and time from the acceleration database 12c (Step S402). That is, the estimation unit 25 estimates the movement direction of the vehicle C10 as the moving object based on the direction of the acceleration detected when the acquired speed changes. Here, there is a case where a predetermined delay (for example, about two seconds) occurs when the movement speed of the vehicle C10 is acquired using the GPS. For example, when the movement speed of the vehicle C10 is acquired using the GPS in a case where the vehicle C10 is moving at speed “B” in a date and time “A”, the speed “B” is measured as the speed of the vehicle C10 in a date and time that is delayed by about two seconds from the date and time “A”. Thus, the estimation unit 25 extracts an average value calculated from accelerations measured a predetermined period before the specified date and time from the acceleration database 12c.

For example, as illustrated in (F) in FIG. 1, the estimation unit 25 extracts an average value of accelerations detected earlier by the time obtained by considering the delay of the GPS speed than the time when a value of the change amount exceeds the predetermined threshold. For example, when a value of the change amount #2 exceeds the predetermined threshold, the estimation unit 25 specifies a date and time when the change amount #2 is acquired, for example, a median of dates and times when the GPS speed #2 and the GPS speed #3 are acquired, and specifies that an average value calculated from acceleration acquired two seconds before the specified median is the average value #1. In such a case, the estimation unit 25 extracts the average value #1 from the acceleration database 12c.

To give a more specific example, the estimation unit 25 refers to the GPS speed database 12b and specifies a date and time associated with a change amount of 2 km/h/s or more, or −2 km/h/s or less, that is, the date and time when acceleration or deceleration is performed by the predetermined threshold or more. For example, when information illustrated in FIG. 3 is registered in the GPS speed database 12b, the estimation unit 25 specifies a date and time “2016/10/1/10:00:17” associated with a change amount “18 km/h/s”. In such a case, the estimation unit 25 calculates a date and time “2016/10/1/10:00:15” two seconds before “2016/10/1/10:00:17” in consideration of the delay of the GPS, and extracts an average value of accelerations associated with the calculated date and time “2016/10/1/10:00:15” from the acceleration database 12c. For example, when information illustrated in FIG. 4 is registered in the acceleration database 12c, the estimation unit 25 extracts the average value “average value #1” of the acceleration associated with the date and time “2016/10/1/10:00:15”. That is, the estimation unit 25 extracts the acceleration associated with the date and time “2016/10/1/10:00:15” as the average value of accelerations caused by acceleration or deceleration in which the GPS speed is greatly changed.

Incidentally, when acquiring the movement speed of the vehicle C10 from the control device of the information system or the control system provided in the vehicle C10, the terminal device 10 can acquire the movement speed of the vehicle C10 substantially in real time. Thus, when the movement speed of the vehicle C10 has been acquired from the control device of the information system or the control system provided in the vehicle C10, the estimation unit 25 may extract an average value of acceleration detected at the same time as the time when the change amount in speed of the vehicle C10 exceeds the predetermined threshold and acceleration detected in a same period as the time when the change amount in speed of the vehicle C10 exceeds the predetermined threshold.

Here, it is considered that acceleration in the Z axis direction is detected in the vehicle coordinate system when the vehicle C10 is accelerated, and acceleration in the −Z axis direction is detected in the vehicle coordinate system when the vehicle C10 is decelerated. Thus, the estimation unit 25 specifies whether the vehicle C10 as the moving object is accelerated or decelerated based on the acquired change in speed, and estimates the movement direction of the moving object based on a direction of the detected acceleration and whether the moving object is accelerated or decelerated. More specifically, when the GPS speed indicates deceleration (for example, when a value of the change amount is negative), the estimation unit 25 reverses the sign of the extracted average value (Step S403) to align the direction of the acceleration extracted from the acceleration database 12c. That is, the estimation unit 25 sets the direction of the detected acceleration as a direction opposite to the movement direction of the moving object when it is determined that the vehicle C10 is accelerated, and sets the direction of the detected acceleration as the movement direction of the moving object when it is determined that the vehicle C10 is decelerated.

Further, the estimation unit 25 registers the extracted average value in the average value database 12d (Step S404). That is, the estimation unit 25 registers acceleration on a plane perpendicular to a gravity direction, that is, the acceleration estimated when the vehicle C10 is accelerated or decelerated by a predetermined threshold or more in the average value database 12d as a collected average value. Incidentally, when a predetermined number of collected average values are registered in the average value database 12d, the estimation unit 25 may eliminate a collected average value with the oldest registered date and time or date and time when acceleration as a calculation source has been measured, and register a newly extracted average value as the collected average value in the average value database 12d. In addition, the estimation unit 25 may execute the above-described process every time when the change amount of the GPS speed whose absolute value is larger than a predetermined threshold is measured.

Further, the estimation unit 25 estimates the movement direction of the vehicle C10 based on an average value of the average values registered in the average value database 12d (Step S405). Here, the average value registered in the acceleration database 12c is the acceleration on the plane perpendicular to the direction of gravity, that is, the average value on the YZ plane. Thus, the estimation unit 25 calculates a further average value of the average values registered in the average value database 12d to specify the direction of the acceleration generated when the vehicle C10 performs linear acceleration, that is, the direction of the acceleration in the Z axis in the vehicle coordinate system.

That is, the estimation unit 25 estimates the direction on the plane perpendicular to the direction of gravity as the movement direction of the vehicle C10. More specifically, the conversion unit 23 performs the C1 conversion of the direction of the detected acceleration in the direction on the plane perpendicular to the direction of gravity. Further, the estimation unit 25 estimates the movement direction of the vehicle C10 on the plane perpendicular to the direction of gravity based on an average value of the converted accelerations. Further, the estimation unit 25 calculates a coordinate conversion formula to convert the terminal coordinate system to the vehicle coordinate system (that is, a coordinate conversion formula to convert the acceleration subjected to the C1 conversion into the vehicle coordinate system) based on the estimated movement direction of the vehicle C10 as the C2 conversion formula (Step S406). Thereafter, the determination unit 26 converts the acceleration measured by the acceleration sensor from the terminal coordinate system into the vehicle coordinate system using the C2 conversion formula, and estimates the movement state of the vehicle C10 based on the converted acceleration (Step S407).

For example, the estimation unit 25 corrects a direction of the average value depending on acceleration or deceleration, and continues to collect the average value as illustrated in (G) in FIG. 1. In addition, the estimation unit 25 further calculates an average value of the collected average values, that is, the average value of the average values registered in the average value database 12d, estimates the movement direction of the vehicle C10 based on the calculated average value, and calculates the C2 conversion formula based on the estimated movement direction of the vehicle C10 as illustrated in (H) in FIG. 1.

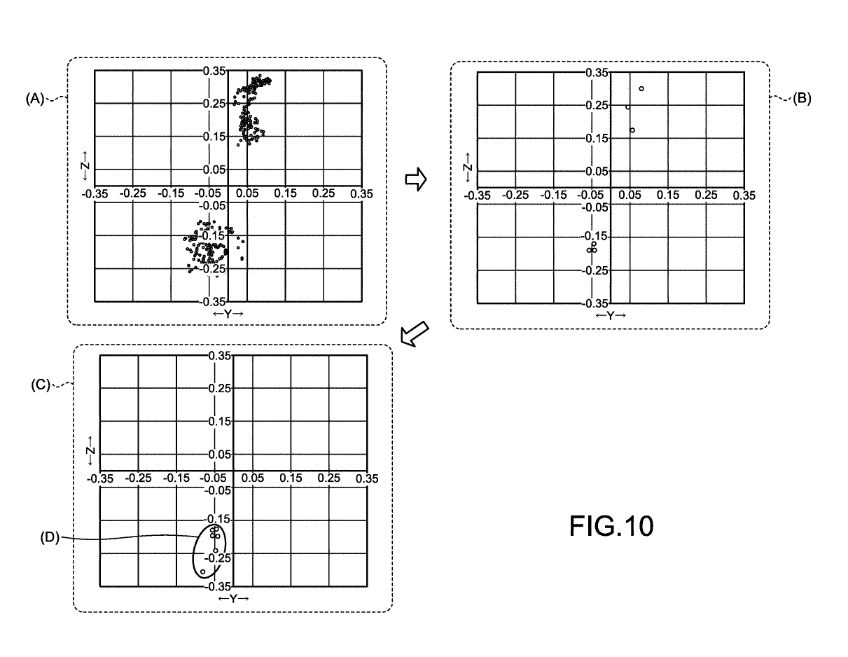

For example, FIG. 10 is a view illustrating an example of acceleration acquired by the terminal device according to the embodiment. Incidentally, as illustrated in (A) to (C) in FIG. 10, the drawing obtained by plotting the acceleration subjected to the C1 conversion on the YZ plane is described in the example illustrated in FIG. 10. For example, the drawing illustrated in (A) in FIG. 10 is the drawing obtained by performing the C1 conversion on a plurality of accelerations estimated to have been generated during a period (for example, one second) in which the change amount of the GPS speed exceeds the predetermined threshold and plotting the accelerations subjected to the C1 conversion on the YZ plane. Here, since the movement direction of the vehicle C10 is unknown in the C1 conversion, a direction of rotation about the Z axis is not accurate. Thus, when the acceleration generated at the time of acceleration or deceleration of the vehicle C10 is subjected to the C1 conversion and plotted on the YZ plane as illustrated in (A) in FIG. 10, a deviation is caused between the acceleration and the Z axis, and it is unclear which one between the −Z axis direction and the Z axis direction is the movement direction.

Thus, the terminal device 10 specifies the movement direction of the vehicle C10 using the average value of the accelerations subjected to the C1 conversion on the YZ plane. For example, the terminal device 10 calculates an average value of accelerations subjected to the C1 conversion for each period during which the accelerations are measured as illustrated in (B) in FIG. 10. Then, the terminal device 10 can obtain an average value of directions of accelerations generated by acceleration and an average value of directions of accelerations generated by deceleration as illustrated in (B) in FIG. 10.

Further, the terminal device 10 reverses the direction of acceleration generated by deceleration among the averages of the accelerations illustrated in (B) in FIG. 10 on the YZ plane. For example, the terminal device 10 rotates a direction of the average value of the acceleration estimated to have been generated when the change amount of the GPS speed is negative by 7c on the YZ plane using the X axis as the center thereof as illustrated in (C) in FIG. 10. Further, the terminal device 10 calculates the average value of the directions of the respective accelerations and sets a direction of the calculated average value as the direction of the acceleration generated by acceleration of the vehicle C10, that is, the +Z axis direction as illustrated in (D) in FIG. 10. As a result, the terminal device 10 can obtain an angle α between the Z axis and the z axis using the X axis direction as the center thereof. Incidentally, the terminal device 10 may calculate angles between the average values illustrated in (C) in FIG. 10 and the +Z axis direction, respectively, and set an average value of the calculated angles as the angle α between the Z axis and the z axis using the X axis direction as the center thereof.

Further, the determination unit 26 calculates the movement direction and speed of the vehicle C10 based on the acceleration measured by the acceleration sensor 13 using the C2 conversion formula. For example, the estimation unit 25 performs the C1 conversion of the acceleration measured by the acceleration sensor 13, and generates a C2 conversion formula so as to convert the acceleration measured by the acceleration sensor from the terminal coordinate system into the vehicle coordinate system when the C2 conversion formula is applied to the acceleration after being subjected to the C1 conversion.

Further, the determination unit 26 estimates the movement direction of the vehicle C10 using the acceleration after being subjected to the C2 conversion. For example, the determination unit 26 determines that the vehicle C10 is accelerating when the acceleration in the +Z axis direction is measured, and determines that the vehicle C10 is decelerating when the acceleration in the −Z axis direction is detected. In addition, the determination unit 26 determines that the vehicle C10 has turned right when the acceleration in the +Y axis direction perpendicular to the −Z axis direction as the movement direction is measured, and determines that the vehicle C10 has turned left when the acceleration in the −Y axis direction is measured.

In addition, the determination unit 26 calculates the movement speed of the vehicle C10 using the converted acceleration. Specifically, the determination unit 26 sets an integral value of Z axis components of acceleration as the movement speed of the vehicle C10 with an average value of the Z axis components of the acceleration at the time of stop of the vehicle C10 as an origin (0) thereof. Incidentally, the determination unit 26 may correct the integral value to zero when it is determined that the vehicle C10 is not moving in order to eliminate accumulation of errors caused by adopting the integral value. For example, the determination unit 26 may determine whether or not the vehicle C10 is stopped using the SVM that has learned the feature amount of the acceleration at the time of stop of the vehicle C10, and correct the integral value to zero when it is determined that the vehicle C10 is stopped. In this manner, the determination unit 26 performs estimation of the movement speed and the movement direction of the vehicle C10 using the acceleration measured by the acceleration sensor 13.

2-6. Example of Flow of Processing

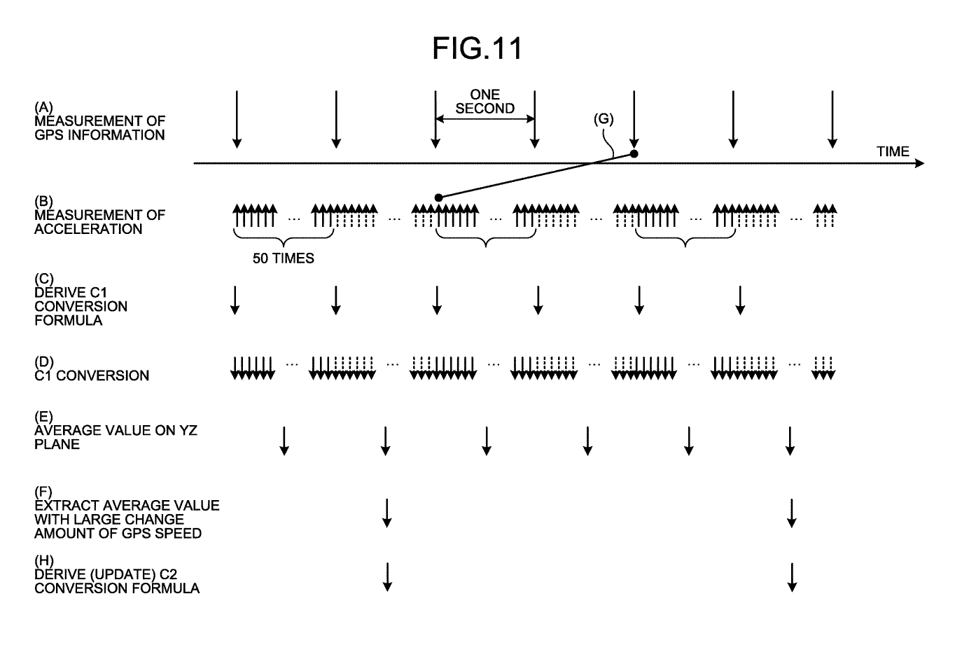

Next, an example of a process of processing in which the terminal device 10 estimates the movement direction will be described with reference to FIG. 11. FIG. 11 is a view illustrating the example of the process of the processing in which the terminal device according to the embodiment estimates the movement direction. For example, the terminal device 10 performs measurement of GPS information at an interval of one second as illustrated in (A) in FIG. 11, and performs measurement of acceleration according to the terminal coordinate system with a rate of about 50 times during one second as illustrated in (B) in FIG. 11.

In such a case, the terminal device 10 calculates the average value of the accelerations at the predetermined time interval, and derives the C1 conversion formula (rotation matrix) to perform the C1 conversion to convert the x axis direction of the terminal coordinate system into the X axis direction of the vehicle coordinate system at a predetermined time interval by considering the direction of the average value of the calculated accelerations as the reference direction as illustrated in (C) in FIG. 11. Further, the terminal device 10 executes the C1 conversion to covert the measured acceleration using the C1 conversion formula as illustrated in (D) in FIG. 11.

Subsequently, the terminal device 10 calculates an average value on the YZ plane from the accelerations after being subjected to the C1 conversion as illustrated in (E) in FIG. 11. In addition, the terminal device 10 extracts an average value estimated to have been acquired when the change amount of the GPS speed calculated based on the GPS information exceeds the predetermined threshold as illustrated in (F) in FIG. 11. For example, as illustrated in (G) in FIG. 11, the terminal device 10 extracts the average value calculated from the acceleration a predetermined period (for example, two seconds) before the time when it is determined that the change amount of the GPS speed exceeds the predetermined threshold in consideration of a delay amount relating to the acquisition of the GPS speed.

Further, the terminal device 10 derives the C2 conversion formula for conversion from the terminal coordinate system into the vehicle coordinate system using the extracted average value as illustrated in (H) in FIG. 11. More specifically, the terminal device 10 derives a new C2 conversion formula every time when the change amount of the GPS speed exceeds the predetermined threshold. As a result, at the time of initial setting, the terminal device 10 promptly estimates the movement direction of the vehicle C10, derives the C1 conversion formula and the C2 conversion formula, and updates the C1 conversion formula and the C2 conversion formula at a certain time interval, and thus, the estimation accuracy can be maintained.

2-7. Example of Mathematical Expression

Next, an example of a process of calculating the C2 conversion formula to convert the terminal coordinate system to the vehicle coordinate system by the estimation unit 25 will be described using mathematical expressions. Incidentally, the process executed by the estimation unit 25 is not limited to the process indicated by the following mathematical expressions. For example, the estimation unit 25 may perform coordinate conversion from the terminal coordinate system to the vehicle coordinate system using a mathematical expression expressing the primary conversion.

For example, the respective axes of the terminal coordinate system are set as the x axis, the y axis, and the z axis, and the respective axes of the vehicle coordinate system are set as the X axis, the Y axis, and the Z axis. In such a case, a process of converting the vehicle coordinate system into the terminal coordinate system is expressed by the following Formula (1). Incidentally, a rotation angle about the x axis is α, a rotation angle about the γ axis is β, a rotation angle about the z axis is γ, a rotation matrix to perform coordinate conversion by rotation about the x axis is Rₓ(α), a rotation matrix to perform coordinate conversion by rotation about the y axis is R_{y}(β), and a rotation matrix to perform coordinate conversion by rotation about the z axis is R_{z}(γ) in Formula (1).

$$( \begin{matrix}x \\ y \\ z\end{matrix} ) = {R}_{z} ( γ ) {R}_{y} ( β ) {R}_{x} ( α ) ( \begin{matrix}X \\ Y \\ Z\end{matrix} ) \qquad ( 1 )$$

In addition, the rotation matrix Rₓ(α), the rotation matrix R_{y}(β), and the rotation matrix R_{z}(γ) (hereinafter, collectively referred to as “the respective rotation matrices” in some cases) can be expressed by the following Formulas (2) to (4).

$$\begin{matrix}{R}_{x} ( α ) = ( \begin{matrix}1 & 0 & 0 \\ 0 & cos α & - sin α \\ 0 & sin α & cos α\end{matrix} ) & ( 2 ) \\ {R}_{y} ( β ) = ( \begin{matrix}cos β & 0 & sin β \\ 0 & 1 & 0 \\ - sin β & 0 & cos β\end{matrix} ) & ( 3 ) \\ {R}_{z} ( γ ) = ( \begin{matrix}cos γ & - sin γ & 0 \\ sin γ & cos γ & 0 \\ 0 & 0 & 1\end{matrix} ) & ( 4 )\end{matrix}$$

Here, the direction of the average vector G is the acceleration in the −X axis direction, and thus, can be expressed by the following Formula (5) in the vehicle coordinate system.

$$( \begin{matrix}X \\ Y \\ Z\end{matrix} ) = ( \begin{matrix}- G \\ 0 \\ 0\end{matrix} ) \qquad ( 5 )$$

On the other hand, the average vector G in the respective axis directions detected in the terminal coordinate system is described as (aₓ, a_{y}, a_{z}). In such a case, aₓ, a_{y}, and a_{z} are values obtained by converting the average vector G expressed by the Formula (5) with the respective rotation matrices, and thus, the following Formula (6) is established.

$$( \begin{matrix}{a}_{x} \\ {a}_{y} \\ {a}_{z}\end{matrix} ) = {R}_{z} ( γ ) {R}_{y} ( β ) {R}_{x} ( α ) ( \begin{matrix}- G \\ 0 \\ 0\end{matrix} ) = ( \begin{matrix}- G cos β cos γ \\ - G cos β sin γ \\ G sin β\end{matrix} ) \qquad ( 6 )$$

As a result, Formula (7) is obtained from a value in the z axis direction in Formula (6).

$$sin β = \frac{{a}_{z}}{G} \qquad ( 7 )$$

In addition, since the Formula (8) is established by standardization in consideration of the magnitude of the average vector G, the Formula (9) is obtained from values in the x axis direction and the y axis direction in the Formula (6). As a result, the terminal device 10 can specify the rotation angle β around the y axis from the Formulas (7) and (9).

$$\begin{matrix}{G}^{2} = {a}_{x}^{2} + {a}_{y}^{2} + {a}_{z}^{2} & ( 8 ) \\ cos β = \pm \sqrt{1 - {( \frac{{a}_{z}}{G} )}^{2}} = \pm \frac{\sqrt{{a}_{x}^{2} + {a}_{y}^{2}}}{G} & ( 9 )\end{matrix}$$

Here, if cases are divided depending on a sign of a value expressed in the Formula (9), the following Formulas (10) to (13) can be obtained as solutions of Formula (6).

$$\begin{matrix}sin β = \frac{{a}_{z}}{G} & ( 10 ) \\ cos β = \sqrt{1 - {( \frac{{a}_{z}}{G} )}^{2}} & ( 11 ) \\ sin γ = - \frac{{a}_{y}}{\sqrt{{a}_{x}^{2} + {a}_{y}^{2}}} & ( 12 ) \\ cos γ = - \frac{{a}_{x}}{\sqrt{{a}_{x}^{2} + {a}_{y}^{2}}} & ( 13 )\end{matrix}$$

On the other hand, a process of converting the terminal coordinate system into the vehicle coordinate system is inverse conversion of the coordinate conversion expressed in the Formula (1), and thus, is expressed by the following Formula (14).

$$( \begin{matrix}X \\ Y \\ Z\end{matrix} ) = {R}_{x} ( - α ) {R}_{y} ( - β ) {R}_{z} ( - γ ) ( \begin{matrix}x \\ y \\ z\end{matrix} ) \qquad ( 14 )$$

In addition, the values of β and γ have been already derived from Formulas (10) to (13), and thus, the C1 conversion, which causes only the y axis and the z axis among the accelerations aₓ, a_{y}, and a_{z} in the terminal coordinate system to be rotated and the x axis of the terminal coordinate system to match the X axis of the vehicle coordinate system can be expressed by Formula (15).

$$( \begin{matrix}x \\ y \\ z\end{matrix} ) = {R}_{y} ( - β ) {R}_{z} ( - γ ) ( \begin{matrix}{a}_{x} \\ {a}_{y} \\ {a}_{z}\end{matrix} ) \qquad ( 15 )$$

Here, the terminal device 10 may calculate the direction on the YZ plane of the acceleration determining the movement direction, that is, the acceleration estimated to have been generated when the GPS speed greatly changes, and calculate the rotation angle α about the x axis (the same as the X axis after being subjected to C1 conversion) such that the calculated direction matches the Z axis direction. For example, in a case where the acceleration estimated to have been generated when the GPS speed greatly changes is taken as a sample, Formula (16) is obtained when a sample of the acceleration in the y axis direction is set as y, a sample of the acceleration in the z axis direction is set as z, and components of samples of the accelerations projected on the YZ plane are set as y′ and z′.

$$( \begin{matrix}{y}^{′} \\ {z}^{′}\end{matrix} ) = ( \begin{matrix}cos α & sin α \\ - sin α & cos α\end{matrix} ) ( \begin{matrix}y \\ z\end{matrix} ) \qquad ( 16 )$$

Here, when a rotation angle between the y axis direction and the z′ axis direction is set as θ, α can be expressed by the following Formula (17), and the sine and the cosine of θ are expressed by the following Formulas (18) and (19), respectively.

$$\begin{matrix}α = θ - \frac{π}{2} & ( 17 ) \\ sin θ = \frac{z}{\sqrt{{y}^{2} + {z}^{2}}} & ( 18 ) \\ cos θ = \frac{y}{\sqrt{{y}^{2} + {z}^{2}}} & ( 19 )\end{matrix}$$

Here, from the Formulas (17) to (19), a value of y′ becomes zero as expressed in the following Formula (20). More specifically, the following Formulas (21) and (22) are established from Formula (17). As a result, Formula (20) is established by converting each left side of the Formulas (18) and (19) into the equation of a using Formulas (21) and (22) and substituting Formula (16) with the result.

y′=0 (20)

cos α=sin θ (21)

sin α=−cos θ (22)

To summarize the above-described calculation results, the C1 conversion formula represented by the following Formula (23) can be expressed by the following Formula (24).

$$\begin{matrix} ( \begin{matrix}{x}^{′} \\ {y}^{′} \\ {z}^{′}\end{matrix} ) = {R}_{y} ( - β ) {R}_{z} ( - γ ) ( \begin{matrix}x \\ y \\ z\end{matrix} ) & ( 23 ) \\ ( \begin{matrix}{x}^{′} \\ {y}^{′} \\ {z}^{′}\end{matrix} ) = {R}_{y} ( - β ) ( \begin{matrix}cos γ & sin γ & 0 \\ - sin γ & cos γ & 0 \\ 0 & 0 & 1\end{matrix} ) ( \begin{matrix}x \\ y \\ z\end{matrix} ) = ( \begin{matrix}( x cos γ + y sin γ ) cos β - z sin β \\ - x sin γ + y cos γ \\ ( x cos γ + y sin γ ) sin β + z cos β\end{matrix} ) & ( 24 )\end{matrix}$$

In addition, the C2 conversion formula to perform the C2 conversion can be expressed by the following Formula (25) by rotating the acceleration subjected to the C1 conversion about the X axis.

$$( \begin{matrix}X \\ Y \\ Z\end{matrix} ) = ( \begin{matrix}1 & 0 & 0 \\ 0 & cos α & sin α \\ 0 & - sin α & cos α\end{matrix} ) ( \begin{matrix}{x}^{′} \\ {y}^{′} \\ {z}^{′}\end{matrix} ) = ( \begin{matrix}{x}^{′} \\ {y}^{′} cos α + {z}^{′} sin α \\ - {y}^{′} sin α + {z}^{′} cos α\end{matrix} ) \qquad ( 25 )$$

### 3. Modified Example

The terminal device 10 according to the above-described embodiment may be implemented in various different modes other than the above-described embodiment. Thus, another embodiment of the above-described terminal device 10 will be described hereinafter.

3-1. Regarding Weighting

Here, the movement direction of the vehicle C10 is estimated based on the direction of the acceleration in the estimation process described above. However, the embodiment is not limited thereto. For example, the terminal device 10 may estimate the movement direction of the vehicle C10 in consideration of the magnitude of the acceleration. For example, when great acceleration or deceleration occurs during traveling of the vehicle C10, it is predicted that the vehicle C10 has traveled straight. For example, it is predicted that great acceleration or deceleration, and a high acceleration in turn, is to be measured when the vehicle stops at a signal intersection and then accelerates or when sudden braking is performed. In such a state, the vehicle C10 is predicted to be in a straight traveling state. Thus, acceleration higher than a predetermined threshold becomes more reliable data at the time of estimating the movement direction of the vehicle C10 than acceleration lower than the predetermined threshold.

Thus, the terminal device 10 may estimate the movement direction of the vehicle C10 as the moving object using a plurality of detected accelerations in the state of considering weighting based on each magnitude of the accelerations. More specifically, the terminal device 10 may estimate the movement direction of the vehicle C10 by performing the weighting with respect to each acceleration such that a weight increases as the magnitude of the acceleration increases.

For example, the terminal device 10 may perform the weighting according to the magnitude of the acceleration when calculating an average value of accelerations used at the time of estimating the movement direction of the vehicle C10, that is, when performing the C1 conversion on the accelerations detected by the acceleration sensor 13 and calculating the average value of the accelerations after being subjected to the C1 conversion. To give a more specific example, for example, when a vector of the acceleration subjected to the C1 conversion is described as aᵢ (in the mathematical expression, a is indicated by a bold letter, which is similarly applied hereinafter), the terminal device 10 may calculate an average value using a value obtained by integrating the |aᵢ| which is a norm of the vector aᵢ and the predetermined weighting coefficient w with the vector aᵢ as expressed in the following Formula (26) as a value of the vector aᵢ.

aᵢ→w·|aᵢ|·aᵢ (26)

In addition, the terminal device 10 may estimate the movement direction of the vehicle C10 as the moving object based on an average value of directions of a plurality of accelerations in consideration of the weighting based on the magnitude of each acceleration. That is, the terminal device 10 may consider the weighting based on a magnitude of each average value at the time of calculating the rotation direction about the X axis from the average value of the accelerations acquired when the change amount of the GPS speed becomes larger than the predetermined threshold, that is, the average value registered in the average value database 12d. For example, when the vector of the average value registered in the average value database 12d is set as the vector aᵢ and an angle between a direction of the vector aᵢ and the −Z axis direction is set as θi, the terminal device 10 may calculate an average value of angles between the −Z axis direction and the respective average values using a formula represented by the following Formula (27) and estimate the movement direction of the vehicle C10.

$$\frac{\sum {θ}_{i}}{\sum 1} \to \frac{\sum w \cdot \vert {a}_{i} \vert \cdot {θ}_{i}}{\sum w \cdot \vert {a}_{i} \vert} \qquad ( 27 )$$

Incidentally, the above-described Formulas (26) and (27) are merely examples, and the terminal device 10 may adopt an arbitrary formula in consideration of the weighting based on the magnitude of the acceleration as long as the movement direction of the vehicle C10 is estimated. In addition, the weighting process described above is implemented by the estimation unit 25 illustrated in FIG. 2, for example.

3-2. Regarding Posture Detection Function

Here, when the terminal device 10 is implemented by a mobile terminal device such as a smart device or the like, it is predicted that the user conducts behavior such as performing search processing using the terminal device 10 and leaving the vehicle C10 directly possessing the terminal device 10. Thus, there is a risk that the installation posture of the terminal device 10 may change. However, when the terminal device 10 estimates the movement direction and the movement speed of the vehicle C10 using the C1 conversion formula and the C2 conversion formula obtained before the installation posture changes despite the change of the installation posture, the accuracy in estimation of the movement direction and the movement speed deteriorates.

Therefore, the terminal device 10 may include a means for detecting the change of the installation posture, calculate the C1 conversion formula and the C2 conversion formula again in the case of detecting the change of the installation posture, and convert the acceleration in the terminal coordinate system into the acceleration in the vehicle coordinate system using the C1 conversion formula and the C2 conversion formula that have been calculated again. More specifically, the terminal device 10 calculates a first average value, which is an average value of accelerations before a lapse of a predetermined time after detection, and a second average value which is an average value of accelerations before a lapse of a time shorter than the predetermined time. For example, the terminal device 10 calculates a long-term average acceleration (hereinafter, referred to as a “long-term average”) which is continuously calculated while the installation posture does not change and an acceleration average (hereinafter, referred to as a “short-term average”) calculated at a certain interval (for example, one second).

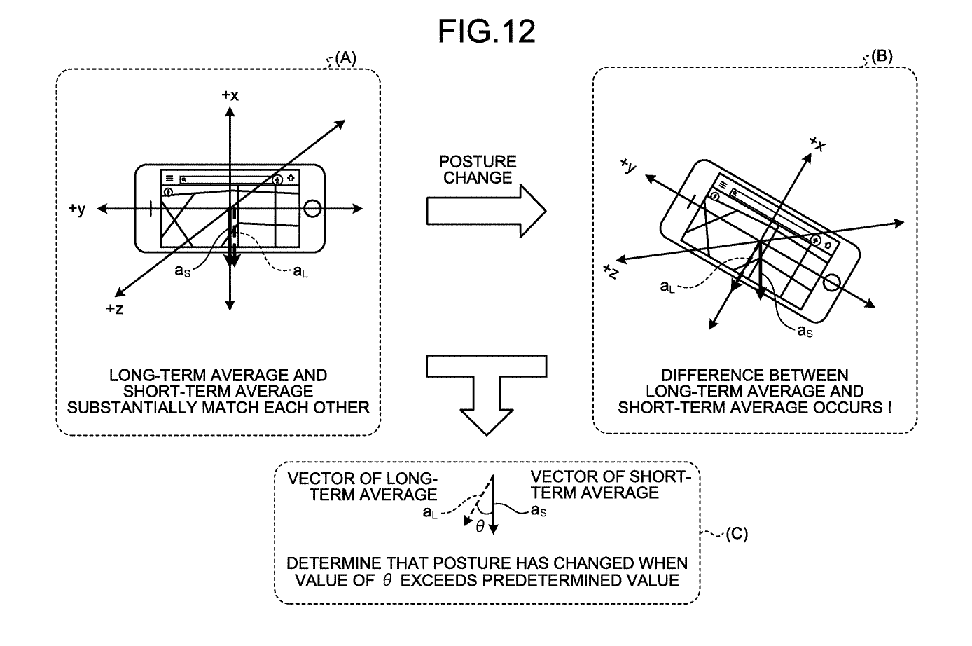

Further, the terminal device 10 may determine whether or not the installation posture of the terminal device 10 has changed based on a difference between the first average value and the second average value, that is, a difference between the long-term average and the short-term average. For example, FIG. 12 is a view illustrating an example of a process of detecting the change of the installation posture by the terminal device according to the embodiment. For example, as illustrated in (A) in FIG. 12, when there is no change in the installation posture during a predetermined period, it is predicted that directions of the long-term average indicated by the dotted arrow and the short-term average indicated by the solid arrow substantially match each other. On the other hand, when the installation posture of the terminal device 10 changes as illustrated in (B) in FIG. 12, it is predicted that the directions of the long-term average indicated by the dotted arrow and the short-term average indicated by the solid arrow are divergent.

Thus, as illustrated in (C) in FIG. 12, when a value of an angle θ between a long-term average vector and a short-term average vector exceeds a predetermined threshold, the terminal device 10 determines that the posture has changed. For example, when a state where a value of a cosine product of the first average value and the second average value exceeds “0.8” continues during a predetermined period, the terminal device 10 may determine that the installation posture of the terminal device 10 has changed. For example, when the long-term average vector is set as a_{L}, the short-term average vector is set as a_{S}, and the angle between the long-term average and the short-term average is set as θ, the terminal device 10 may calculate the value of the cosine product (that is, an inner product) of the long-term average and the short-term average using the following Formula (28) and determine that the installation posture of the terminal device 10 has changed when the calculated value is equal to or less than a predetermined threshold.

|a_{L}|·|a_{S}|·cos θ=a_{L}·a_{S} (28)

Incidentally, for example, when determining that the installation posture of the terminal device 10 has changed, the terminal device 10 erases the information registered in the GPS speed database 12b, the acceleration database 12c, and the average value database 12d, and newly collects GPS speed, a change amount of the GPS speed, acceleration detected by the acceleration sensor 13, and the like. In addition, the terminal device 10 estimates a direction of gravity from an average value of the collected accelerations, and calculates a new C1 conversion formula according to the estimated direction of gravity. Further, the terminal device 10 may estimate a movement direction of the vehicle C10 based on the acceleration when the change amount of the GPS speed exceeds the predetermined threshold, and calculate a new C2 conversion formula based on the estimated movement direction.

In this manner, the terminal device 10 detects the acceleration in the moving object, and calculates the first average value, which is the average value of accelerations before the lapse of the predetermined time after the detection, and the second average value which is the average value of accelerations before the lapse of the time shorter than the predetermined time. Further, the terminal device 10 determines whether or not the posture of the terminal device 10 has changed based on the first average value and the second average value. Thus, the terminal device 10 can easily determine whether or not the installation posture of the terminal device 10 has changed. Incidentally, the process of detecting the change of the installation posture described above may be implemented by the determination unit 26 illustrated in FIG. 2, or implemented by a functional configuration such as a calculation unit and a posture determination unit that is provided separately from the respective units 21 to 26 illustrated in FIG. 2, for example. When the terminal device 10 has such a functional configuration, the calculation unit calculates the first average value and the second average value. Further, the posture determination unit determines whether or not the posture of the terminal device 10 has changed based on the first average value and the second average value calculated by the calculation unit.

3-3. Discrimination Between Curve and Right or Left Turn

Here, the terminal device 10 converts the acceleration in the terminal coordinate system to the acceleration in the vehicle coordinate system using the C2 conversion formula, and estimates the movement direction of the vehicle C10 based on the acceleration in the vehicle coordinate system. For example, the terminal device 10 can estimate that the vehicle C10 has turned to the right or left based on the acceleration in the Y axis direction. However, it is difficult to distinguish whether the vehicle turns a curve at a constant speed, or whether or not the vehicle turns at the intersection only with the acceleration in the Y axis direction.

Here, in the case of performing not only the guidance process but also diagnosis on whether or not driving is appropriate (hereinafter, referred to as “driving ability diagnosis”) using the terminal device 10, it is desirable that the terminal device 10 perform detailed analysis by distinguishing whether the vehicle turns the curve or turns at the intersection. Here, when turning at the intersection, it is predicted that deceleration greater than a predetermined threshold is performed before the right turn or left turn, and acceleration greater than a predetermined threshold is performed after the right turn or left turn. On the other hand, it is considered that great deceleration or acceleration is not performed when the vehicle turns the curve.

Thus, when acceleration in a direction different from the movement direction of the moving object is detected after the speed of the vehicle C10 decelerates, and thereafter, the speed of the vehicle C10 accelerates, the terminal device 10 may determine that the vehicle C10 as the moving object has made a right turn or a left turn. In addition, the terminal device 10 may determine that the vehicle C10 as the moving object is traveling along a curved road when the speed of the terminal device 10 has not decelerated before detection of the acceleration in the direction different from the movement direction of the moving object, or when the speed does not accelerate after detection of the acceleration in the direction different from the movement direction of the moving object.

For example, the terminal device 10 specifies the acceleration in the Y axis direction from the acceleration after being subjected to the C2 conversion. Subsequently, when the acceleration in the Y axis direction exceeds a predetermined threshold, the terminal device 10 specifies a date and time when the acceleration in the Y axis direction exceeds the predetermined threshold as a reference date and time, and sets a few seconds immediately before the reference date and time as an immediately preceding period and a few seconds immediately after the reference date and time as an immediate following period. Further, the terminal device 10 calculates a change amount of speed of the vehicle C10 in the immediately preceding period or the immediately following period using the GPS speed. Incidentally, the terminal device 10 may take into consideration the delay caused at the time of acquiring the GPS speed when performing such calculation. In addition, the terminal device 10 may acquire speed of the vehicle C10 through the general standard configured to acquire information from the control device of the information system or the control system provided in the vehicle C10, and calculate the change amount of the speed of the vehicle C10 in the immediately preceding period or in the immediately following period based on the acquired speed, using OBD or the like.

Further, when the speed of the vehicle C10 decelerates below a predetermined threshold in the immediately preceding period and the speed of the vehicle C10 accelerates above a predetermined threshold in the immediately following period, the terminal device 10 determines that the vehicle C10 has made a right turn or a left turn. On the other hand, when the speed of the vehicle C10 does not decelerate below the predetermined threshold in the immediately preceding period and the speed of the vehicle C10 does not accelerate above the predetermined threshold in the immediately following period, the terminal device 10 determines that the vehicle C10 has turned a curve.

Further, the terminal device 10 may perform the driving ability diagnosis depending on whether or not the vehicle C10 has made a right turn or a left turn, or whether or not the vehicle C10 has turned a curve. For example, in a case where a value of the acceleration measured in the reference date and time is greater than a predetermined threshold when it is determined that the vehicle C10 has made a right turn or a left turn, the terminal device 10 may output a message for calling attention to the user assuming that a sudden right turn or left turn has been made. In addition, in a case where acceleration in the immediate following period is greater than a predetermined threshold when it is determined that the vehicle C10 has made a right turn or a left turn, the terminal device 10 may output the message for calling attention to the user

In this manner, the terminal device 10 detects the acceleration in the moving object. In addition, the terminal device 10 acquires speed of the moving object. Further, the terminal device 10 determines that the moving object has made a right turn or a left turn when the acceleration in the direction different from the movement direction of the moving object is detected after deceleration of the acquired speed, and thereafter, the acquired speed accelerates. The terminal device 10 determines that the moving object is traveling on a curved road when the acquired speed does not decelerate before detection of the acceleration in the direction different from the movement direction of the moving object or when the acquired speed does not accelerate after detection of the acceleration in the direction different from the movement direction of the moving object.

Incidentally, it is possible to consider a case where a certain deceleration or acceleration is hardly detected due to congestion or the like. However, it is possible to consider that such a case may be ignored since there is no problematic driving operation in the case in the first place. Thus, the terminal device 10 may determine whether or not the vehicle C10 is caught in congestion based on information of a road traffic information communication system such as the vehicle information and communication system (VICS) (registered trademark), and does not necessarily perform the determination process on whether or not the vehicle C10 has made a right turn or a left turn or whether or not the vehicle C10 has turned the curve in the case of being caught in congestion. Incidentally, the above-described process of detecting the change in the installation posture may be implemented by the determination unit 26 illustrated in FIG. 2, for example, and may be implemented by a functional configuration such as a movement determination unit provided separately from the respective units 21 to 26 illustrated in FIG. 2, for example.

3-4. Regarding Sudden Braking

In addition, since sudden acceleration and sudden deceleration are one of dangerous driving operations, it is desirable to enable detection of such sudden acceleration and sudden deceleration in the driving ability diagnosis. However, there is a case where sudden acceleration occurs at the time of joining to an expressway when switching from an ordinary road to the expressway. Thus, the accuracy of the driving ability diagnosis deteriorates in a case where it is determined that the dangerous driving operation is performed simply when the sudden acceleration or the sudden deceleration is performed.

Here, when switching from a general road to an expressway, it is predicted that the speed after acceleration will continue for a certain time (for example, 10 minutes) or more after a sudden acceleration. Thus, the terminal device 10 determines whether or not there is acceleration equal to or more than a predetermined threshold, that is, whether or not sudden acceleration has occurred based on the acceleration measured by the acceleration sensor 13, the change amount of the GPS speed, the speed acquired from the control device of the information system or the control system provided in the vehicle C10, and the like. Further, when determining that sudden acceleration has occurred, the terminal device 10 determines whether or not a predetermined speed (for example, 80 km/h or more) has continued during a predetermined period (for example, for 10 minutes) after the sudden acceleration based on the acceleration measured by the acceleration sensor 13, the change amount of the GPS speed, the speed acquired from the control device of the information system or the control system provided in the vehicle C10. Further, when the predetermined speed has continued during the predetermined period after the sudden acceleration, the terminal device 10 may determine that the dangerous driving operation is not performed.

In addition, it is possible to consider a case where it is difficult to acquire GPS speed at the time of sudden acceleration in a tunnel and the like. Thus, when it is difficult to acquire the GPS speed, the terminal device 10 may determine whether or not a certain deceleration has been generated during a predetermined period based on the acceleration detected by the acceleration sensor 13 and determine that the dangerous driving operation is not performed in a case where the certain deceleration has not been generated during the predetermined period.

In this manner, when the speed exceeding the predetermined threshold has not been acquired over the predetermined period after the acceleration exceeding the predetermined threshold is detected by the acceleration sensor 13, the terminal device 10 may determine that the dangerous operation is performed. In addition, when it is difficult to acquire the speed of the moving object such as the GPS speed, the terminal device 10 may determine whether or not the moving body is decelerated based on the acceleration detected by the acceleration sensor 13, and determine that the dangerous operation is performed in a case where the moving body is decelerated during a lapse of the predetermined period. Further, when the speed exceeding the predetermined threshold has been acquired over the predetermined period after detection of the acceleration exceeding the predetermined threshold is detected, the terminal device 10 may determine that the moving object is traveling on a road for high-speed movement.

In this manner, the terminal device 10 acquires the speed of the vehicle C10 using an arbitrary technique such as the acceleration, the GPS speed, or the speed acquired from the control device of the information system or the control system provided in the vehicle C10. In addition, when the change amount of the speed of the vehicle C10 exceeds the predetermined threshold, the terminal device 10 determines whether or not the vehicle C10 is decelerated during the predetermined period. Further, the terminal device 10 determines that the dangerous driving operation is not performed when the vehicle C10 has not decelerated during the predetermined period, and determines that the dangerous driving operation is performed when the vehicle C10 has decelerated during the predetermined period. Incidentally, the above-described process of detecting the change in the installation posture may be implemented by the determination unit 26 illustrated in FIG. 2, for example, and may be implemented by a functional configuration such as an operation determination unit provided separately from the respective units 21 to 26 illustrated in FIG. 2, for example.

3-5. Regarding Processing Interval

In addition, the above-described terminal device 10 may execute the acquisition process, the estimation process, the guidance process, and the like described above at arbitrary time intervals. In addition, the terminal device 10 may divide the acquisition process, the estimation process, and the guidance process into arbitrary processes and independently execute the respective divided processes at arbitrary time intervals. For example, the terminal device 10 may execute acquisition of the acceleration, acquisition of the GPS speed, calculation of a change rate, the C1 conversion and C2 conversion of the acceleration, calculation of the average value of the acceleration, estimation of the movement direction of the vehicle C10, and the like at independent timings.

3-6. Other Embodiments

Incidentally, the above-described embodiment is merely an example, and the present embodiments also include other embodiments exemplified hereinafter and other than the exemplified ones. For example, the functional configuration, the data structure, the order and content of the processing illustrated in the flowchart, and the like in the present application are merely examples, and presence or absence of each element, arrangement thereof, the order of execution of the process and the like, the specific content thereof, and the like can be appropriately changed. For example, the guidance process and the determination process described above can be implemented as devices, methods, or programs in a terminal implemented by an application of a smartphone or the like, instead of being implemented by the terminal device 10 as exemplified in the above-described embodiment.

In addition, a configuration in which the respective processors 17 to 20 forming the terminal device 10 are implemented by independent devices, respectively is general. In addition, it may be configured such that the respective units 21 to 26 forming the movement state determination unit 20 are implemented by independent devices. Similarly, the configuration of the present embodiments can be flexibly changed by implementing each means illustrated in the above-described embodiment by calling an external platform or the like with an application program interface (API) or network computing (a so-called cloud, and the like). Further, each element such as a means relating to the present embodiments may be implemented not only by an arithmetic control unit of a computer but also by another information processing mechanism such as a physical electronic circuit.

For example, the terminal device 10 may execute the above-described guidance process in cooperation of a distribution server communicable with the terminal device 10. For example, the distribution server may include the respective units 21 to 26, execute the detection process, the acquisition process, the estimation process, and the like described above using the acceleration and the GPS speed detected by the terminal device 10, distribute estimation of the movement direction of the vehicle C10, estimation of the movement speed of the vehicle C10, and the like to the terminal device 10, and cause the terminal device 10 to execute guidance of the user.

### 4. Effects

As described above, the terminal device 10 detects the acceleration in the moving object. In addition, the terminal device 10 acquires speed of the moving object. Further, the terminal device 10 estimates a movement direction of the moving object based on a direction of the acceleration detected when the acquired speed changes. For example, the terminal device 10 estimates the movement direction of the moving object based on the direction of the acceleration detected when the acquired change amount in speed exceeds the predetermined threshold.

In this manner, the terminal device 10 estimates the movement direction of the vehicle C10 using the acceleration measured by the acceleration sensor 13 when acceleration or deceleration is performed, and thus, it is possible to accurately estimate the movement direction of the vehicle C10 in a short period of time. In addition, since the terminal device 10 can accurately specify the movement direction of the vehicle C10, it is possible to promptly and accurately perform the determination of acceleration, deceleration, and a right or left turn, and further the estimation (also including stop determination) of speed of the vehicle C10. In addition, the terminal device 10 can promptly and accurately perform the estimation of the installation posture of the terminal device 10. In addition, since the terminal device 10 repeatedly performs estimation of the movement direction of the vehicle C10 using the acceleration measured by the acceleration sensor 13 when acceleration or deceleration is performed, it is possible to reduce an error accompanying a deviation between the terminal coordinate system and the vehicle coordinate system.

In addition, the terminal device 10 can estimate the movement direction of the vehicle C10 in a stand-alone manner using the acceleration and the GPS signal measured by the acceleration sensor 13 installed in the own device. As a result, the terminal device 10 does not necessarily acquire the movement direction of the vehicle C10 from, for example, a server device that estimates the movement direction of the vehicle C10 and the own control device of the vehicle C10, and thus, it is possible to reduce the amount of data to be communicated with these server device and control device.

In addition, since the terminal device 10 can accurately estimate the movement direction of the vehicle C10 without installing the terminal device 10 in the vehicle C10 with a predetermined installation posture, it is possible to make a holder to hold the terminal device 10 with the predetermined installation posture unnecessary. In addition, the terminal device 10 can make manufacturing of the holder or fixing of a direction of the holder unnecessary.

In addition, the terminal device 10 specifies the position of the moving object using the predetermined position positioning system, and acquires the speed of the moving object based on the change of the specified position. For example, the terminal device 10 specifies positions of the moving object at predetermined time intervals, and acquires the speed of the moving object based on a difference between a newly specified position and a previously specified position. Thus, the terminal device 10 can estimate the movement direction of the vehicle C10 in a stand-alone manner without having a function of acquiring the speed from the control device or the like of the vehicle C10.

Here, a GPS for civilian use or the like sometimes contains a predetermined error in advance. Thus, when the movement direction of the vehicle C10 is estimated directly using a position indicated by the GPS, the estimation accuracy deteriorates if the vehicle C10 does not move much more than the error of the GPS. However, the terminal device 10 calculates the GPS speed based on the position indicated by the GPS, and determines acceleration or deceleration of the vehicle C10 based on the calculated change amount of the GPS speed. Further, the terminal device 10 estimates the movement direction of the vehicle C10 based on acceleration accompanying the acceleration or deceleration of the vehicle C10, and thus, it is possible to shorten the time for initial adjustment performed at the start of the guidance process, for example, and to accurately estimate the movement direction of the vehicle C10.

In addition, the terminal device 10 estimates the movement direction of the moving object based on the direction of the acceleration detected the predetermined period before the date and time when the acquired speed changes. That is, the terminal device 10 estimates the movement direction of the moving object based on the direction of the acceleration detected when the speed exceeds the predetermined threshold considering the delay of the GPS speed. Thus, the terminal device 10 can accurately estimate the movement direction of the vehicle C10 even in the case of using the GPS speed.

In addition, the terminal device 10 specifies whether the moving object is accelerated or decelerated based on the acquired change in speed, and estimates the movement direction of the moving object based on the direction of the detected acceleration and whether the moving object is accelerated or decelerated. For example, the terminal device 10 sets the direction of the detected acceleration as a direction opposite to the movement direction of the moving object when determining that the moving object is accelerated, and sets the direction of the detected acceleration as the movement direction of the moving object when determining that the moving object is decelerated. Thus, since the terminal device 10 can estimate the movement direction of the vehicle C10 based on not only the acceleration caused by acceleration of the vehicle C10 but also the acceleration caused by deceleration of the vehicle C10, it is possible to accurately estimate the movement direction of the vehicle C10.

In addition, the terminal device 10 specifies the direction of gravity using the average value of accelerations detected in a predetermined state. Further, the terminal device 10 estimates the direction on the plane perpendicular to the direction of gravity as the movement direction of the moving object. For example, the terminal device 10 converts the direction of the detected acceleration into the direction on the plane perpendicular to the direction of gravity, that is, the YZ plane, and estimates the movement direction of the moving object on the YZ plane based on the average value of the converted accelerations. Thus, since the terminal device 10 can specify the direction of gravity without measuring the acceleration of the vehicle C10 for a long period of time, it is possible to promptly estimate the movement direction of the vehicle C10 with the direction of gravity as the reference.

In addition, the terminal device 10 estimates the movement direction of the moving object using the plurality of detected accelerations in the state of considering the weighting based on the magnitude of the acceleration. For example, the terminal device 10 performs the weighting such that the weight increases as the magnitude of the acceleration increases. In addition, the terminal device 10 estimates the movement direction of the moving object based on the average value of directions of the plurality of detected accelerations in the state of considering the weighting based on each magnitude of the accelerations. As a result, the terminal device 10 can accurately estimate the movement direction of the vehicle C10.

In addition, the terminal device 10 is installed in the moving object and calculates the first average value (that is, the long-term average), which is the average value of accelerations before the lapse of the predetermined time after the detection, and the second average value (that is, the short-term average) which is the average value of accelerations before the lapse of the time shorter than the predetermined time. Further, the terminal device 10 determines whether or not the installation posture of the terminal device 10 has changed based on the first average value and the second average value. Specifically, when the value of the cosine product of the first average value and the second average value is equal to or less than the predetermined threshold during the predetermined period, the terminal device 10 determines that the installation posture has changed. As a result, the terminal device 10 can promptly detect the change of the installation posture, and thus, it is possible to promptly update the C1 conversion formula and the C2 conversion formula, and as a result, it is possible to accurately estimate the movement state of the vehicle C10.

In addition, when the acceleration in the direction different from the estimated movement direction of the moving object is detected after deceleration of the acquired speed, and thereafter, the acquired speed accelerates, the terminal device 10 determines that the moving object has made a right turn or a left turn. In addition, when the speed has not decelerated before detection of the acceleration in the direction different from the estimated movement direction of the moving object, or when the speed has not accelerated after detection of the acceleration, the terminal device 10 determines that the moving object is traveling along the curved road. Thus, the terminal device 10 can separate the case where the vehicle C10 turns right or left and the case where the vehicle C10 is traveling on the curved road in the driving ability diagnosis.

In addition, when the speed exceeding the predetermined threshold has not been acquired over the predetermined period after detection of the acceleration exceeding the predetermined threshold, the terminal device 10 determines that the dangerous operation is performed. As a result, the terminal device 10 can appropriately determine whether or not the vehicle C10 has performed acceleration in order to get on the expressway in the driving ability diagnosis.

In addition, the terminal device 10 determines whether or not the moving object is decelerated based on the detected acceleration when it is difficult to acquire the speed of the moving object, and determines that the dangerous operation is performed when the moving object is decelerated before the lapse of the predetermined period. In addition, when the speed exceeding the predetermined threshold has been acquired over the predetermined period after detection of the acceleration exceeding the predetermined threshold, the terminal device 10 determines that the moving object is traveling on the road for high-speed movement. Thus, the terminal device 10 can implement the driving ability diagnosis in a stand-alone manner even when it is difficult to use the GPS or the like. In addition, the terminal device 10 can reduce the amount of communication with the external server or the like that performs driving ability diagnosis.

In addition, the above-described “unit (section, module, unit)” can be rewritten as a “means”, a “circuit”, or the like. For example, the movement state determination unit can be rewritten as a movement state determination means or a movement state determination circuit.

According to one aspect of the embodiment, an effect that it is possible to estimate the traveling state of the vehicle regardless of the installation posture of the terminal device is obtained.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An estimation device comprising:
a detection unit that detects acceleration in a moving object;
an acquisition unit that acquires speed of the moving object; and
an estimation unit that estimates a movement direction of the moving object based on a direction of the acceleration detected by the detection unit when the speed acquired by the acquisition unit changes.

2. The estimation device according to claim 1, wherein
the acquisition unit specifies a position of the moving object using a predetermined position positioning system, and acquires the speed of the moving object based on a change of the specified position.

3. The estimation device according to claim 2, wherein
the acquisition unit specifies positions of the moving object at predetermined time intervals, and acquires the speed of the moving object based on a difference between a newly specified position and a previously specified position.

4. The estimation device according to claim 2, wherein
the estimation unit estimates the movement direction of the moving object based on a direction of acceleration detected by the detection unit a predetermined period before a date and time when the speed acquired by the acquisition unit changes.

5. The estimation device according to claim 1, wherein
the estimation unit estimates the movement direction of the moving object based on a direction of acceleration detected by the detection unit when a change amount of the speed acquired by the acquisition unit exceeds a predetermined threshold.

6. The estimation device according to claim 1, wherein
the estimation unit specifies whether the moving object is accelerated or decelerated based on a change of the speed acquired by the acquisition unit, and estimates the movement direction of the moving object based on the direction of the acceleration detected by the detection unit and whether the moving object is accelerated or decelerated.

7. The estimation device according to claim 6, wherein
the estimation unit sets the direction of the acceleration detected by the detection unit as a direction opposite to the movement direction of the moving object when determining that the moving object is accelerated, and sets the direction of the acceleration detected by the detection unit as the movement direction of the moving object when determining that the moving object is decelerated.

8. The estimation device according to claim 1, further comprising
a specifying unit that specifies a direction of gravity using an average value of accelerations detected by the detection unit in a predetermined state,
wherein the estimation unit estimates a direction on a plane perpendicular to the direction of gravity as the movement direction of the moving object.

9. The estimation device according to claim 8, wherein
the estimation unit converts the direction of the acceleration detected by the detection unit into the direction on the plane perpendicular to the direction of gravity, and estimates the movement direction of the moving object on the plane perpendicular to the direction of gravity based on an average value of the converted accelerations.

10. The estimation device according to claim 1, wherein
the estimation unit estimates the movement direction of the moving object using a plurality of accelerations detected by the detection unit in the state of considering weighting based on a magnitude of the acceleration.

11. The estimation device according to claim 10, wherein
the estimation unit performs the weighting such that a weight increases as the magnitude of the acceleration increases.

12. The estimation device according to claim 10, wherein
the estimation unit estimates the movement direction of the moving object based on an average value of directions of the plurality of accelerations detected by the detection unit in a state of considering weighting based on the magnitudes of the respective accelerations.

13. The estimation device according to claim 1, the estimation device installed in the moving object, further comprising:
a calculation unit that calculates a first average value, which is an average value of accelerations before a predetermined time elapses from detection by the detection unit, and a second average value, which is an average value of accelerations before a lapse of time shorter than the predetermined time; and
a posture determination unit that determines whether or not a posture of the estimation device installed in the moving object is changed based on the first average value and the second average value.

14. The estimation device according to claim 13, wherein
the posture determination unit determines that the posture of the estimation device is changed when a value of a cosine product of the first average value and the second average value is equal to or less than a predetermined threshold during a predetermined period.

15. The estimation device according to claim 1, further comprising
a movement determination unit that determines a right turn or a left turn has been made by the moving object when acceleration in a direction different from the movement direction of the moving object estimated by the estimation unit is detected by the detection unit, after deceleration of speed acquired by the acquisition unit, and thereafter, speed acquired by the acquisition unit is accelerated.

16. The estimation device according to claim 15, wherein
the movement determination unit determines that the moving object travels along a curved road when the speed is not decelerated before the acceleration in the direction, different from the movement direction of the moving object estimated by the estimation unit, is detected by the detection unit, or when the speed is not accelerated after the corresponding acceleration is detected by the detection unit.

17. The estimation device according to claim 1, further comprising
an operation determination unit that determines that a dangerous operation is performed when speed exceeding a predetermined threshold is not acquired by the acquisition unit over a predetermined period after acceleration exceeding a predetermined threshold is detected by the detection unit.

18. The estimation device according to claim 17, wherein
the operation determination unit determines whether or not the moving object is decelerated based on the acceleration detected by the detection unit when the acquisition unit is incapable of acquiring the speed of the moving object, and determines that the dangerous operation is performed when the moving object is decelerated until a predetermined period elapses.

19. An estimation method executed by an estimation device, the estimation method comprising:
detecting acceleration in a moving object;
acquiring speed of the moving object; and
estimating a movement direction of the moving object based on a direction of the acceleration detected when the speed changes.

20. A non-transitory computer readable storage medium having stored therein an estimation program causing a computer to execute a process comprising:
detecting acceleration in a moving object;
acquiring speed of the moving object; and
estimating a movement direction of the moving object based on a direction of the acceleration detected when the speed changes.
